(19) United States
(12) Patent Application Publication
(10) Pub. No.: US 2025/0039715 A1
(43) Pub. Date: Jan. 30, 2025

(54) Determining a Configuration, Sending a Report to a Network Node, and Receiving a Report from a User Equipment

(71) Applicant: Telefonaktiebolaget LM Ericsson (publ), Stockholm (SE)

(72) Inventors: Zhixun Tang, Beijing (CN); Muhammad Ali Kazmi, Sundbyberg (SE); Santhan Thangarasa, Vällingby (SE); Emre Yavuz, Stockholm (SE); Kazuyoshi Uesaka, Kawasaki, Kanagawa (JP); Zhanxian Wang, Täby (SE)

(21) Appl. No.: 18/716,290

(22) PCT Filed: Jan. 10, 2023
(86) PCT No.: PCT/SE2023/050026

§ 371 Date: Jun. 4, 2024

(30) Foreign Application Priority Data
Jan. 10, 2022 (WO) PCT/CN2022/071017

(51) Int. Cl. H04W 24/10; H04L 5/00

(52) U.S. Cl. CPC H04W 24/10; H04L 5/0035; H04L 5/0048; H04L 5/0094

(57) ABSTRACT

Methods and apparatus such as User Equipments (UEs) and network nodes are provided. In an example, a method in a network node of determining a configuration of a User Equipment (UE) to perform a measurement on a second cell is provided, wherein the UE is served by a first cell. The method comprises determining whether the measurement is an inter-frequency measurement or an intra-frequency measurement based on a reference frequency and a frequency of a reference signal on the second cell, wherein the reference frequency comprises a frequency of a reference signal of an active bandwidth part (BWP) of the UE.

### TECHNICAL FIELD

Example embodiments of this disclosure relate to determining a configuration, sending a report to a network node, and receiving a report from a User Equipment (UE).

### BACKGROUND

Procedures and requirements to support reduced capability (Redcap) User Equipments (UEs), which entail characteristics such as low complexity and low power consumption, are being specified in 3GPP Rel-17. A RedCap UE will support the following UE complexity reduction features:
Reduced maximum UE bandwidth:
Maximum bandwidth of an FR1 RedCap UE during and after initial access is 20 MHz.
Maximum bandwidth of an FR2 RedCap UE during and after initial access is 100 MHz.
Reduced minimum number of Rx branches:
For frequency bands where a legacy NR UE is required to be equipped with a minimum of 2 Rx antenna ports, the minimum number of Rx branches supported by specification for a RedCap UE is 1. The specification also supports 2 Rx branches for a RedCap UE in these bands.
For frequency bands where a legacy NR UE (other than 2-Rx vehicular UE) is required to be equipped with a minimum of 4 Rx antenna ports, the minimum number of Rx branches supported by specification for a RedCap UE is 1. The specification also supports 2 Rx branches for a RedCap UE in these bands.
Maximum number of DL MIMO layers:
For a RedCap UE with 1 Rx branch, 1 DL MIMO layer is supported.
For a RedCap UE with 2 Rx branches, 2 DL MIMO layers are supported.
Relaxed maximum modulation order:
Support of 256QAM in DL is optional (instead of mandatory) for an FR1 RedCap UE.
No other relaxations of maximum modulation order are specified for a RedCap UE.
Duplex operation: FDD, HD-FDD and TDD

A redcap capable UE may also be called a bandwidth reduced (BR) UE within in context of NR. A non-bandwidth reduced (non-BR) UE may refer to a legacy UE, which can operate on any bandwidth supported by certain frequency band. For example, non-BR UE may operate on a BW up to 40 MHz while the BR UE may UE may operate on a BW up to 20 MHz in the same frequency band.

### Initial Downlink BWP

Initial BWP is used at least during the initial access. The first initial downlink (DL) BWP configured in MIB is CORESET #0 (which is known as MIB-configured initial DL BWP). After reception of CORESET #0 and decoding SIB1, a UE can have the configuration of a SIB-configured initial DL BWP. Specifically, the BWP configuration (IE initialDownlinkBWP) provides information about the bandwidth and location of the initial DL BWP, subcarrier spacing, and cell-specific PDCCH and PDSCH parameters of the BWP.

To efficiently support UEs with different capabilities (e.g., bandwidth) in a network, it is important to ensure an efficient coexistence of different UEs (e.g., RedCap UEs and non-RedCap or legacy UEs) while considering resource utilization, network spectral/energy efficiency, UE complexity and power consumption. In this regard, there are various discussions in the 3GPP to enable an efficient support of RedCap UEs in a network. One of the key discussions is related to the initial DL bandwidth part (BWP) and the need for having separate SIB-configured initial DL BWPs for RedCap and non-RedCap UEs. In general, using a separate SIB-configured initial DL BWP for RedCap can be beneficial for flexibility and offloading purposes.

### SSB

During cell search, a UE aims at acquiring time and frequency synchronization with a cell and to detect physical layer cell ID (PCI) of the cell. In NR, the synchronization signal block (SS block or SSB) consists of primary and secondary synchronization signals (PSS and SSS) and physical broadcast channel (PBCH). During the initial cell search, the UE first aims at detecting PSS and then SSS. Time and frequency synchronization as well as cell ID detection are done using PSS and SSS. Proper detection of PSS and SSS is an essential step for PBCH demodulation. PBCH carries basic system information such as master information block (MIB) and determines essential parameters for initial access of the cell, including the downlink system bandwidth and the system frame number. For PBCH, polar coding and QPSK modulation are used. The SSB periodicity can be {5, 10, 20, 40, 80, 160} ms, configured via RRC parameters. However, a default periodicity of 20 ms is assumed during initial cell search. To support initial access and beam management, NR supports SS burst set which consists of multiple SS blocks confined within a 5 ms window. Depending on the carrier frequency, up to 64 SS blocks can be transmitted within a SS burst set. In frequency domain, one SSB block occupies 20 contiguous resource blocks which is equivalent to 240 subcarriers. In time domain, one SSB block spans over 4 OFDM symbols (as illustrated in FIG. 1).

Within the frequency span of a carrier, multiple SSBs can be transmitted. The PCIs of SSBs transmitted in different frequency locations do not have to be unique, i.e. different SSBs in the frequency domain can have different PCIs.

However, when an SSB is associated with a Remaining Minimum System Information (RMSI), the SSB is referred to as a Cell-Defining SSB (CD-SSB). A PCell is always associated to a CD-SSB located on the synchronization raster. If a separate initial/RRC configured DL BWP is configured to contain the entire CORESET #0, CD-SSB is expected by RedCap UE.

Non-Cell-Defining SSB (NCD-SSB) which is not associated with CORESET #0 is mainly used for some RRM procedures e.g. performing measurements. For a separate initial DL BWP (if it does not include CD-SSB and the entire CORESET #0), if it is configured for paging, RedCap UE expects it to contain NCD-SSB for serving cell but not CORESET #0/SIB. For an RRC-configured active DL BWP in connected mode (if it does not include CD-SSB and the entire CORESET #0), a RedCap UE supporting mandatory FG 6-1 (but not optional FG 6-1a) expects it to contain NCD-SSB for serving cell but not CORESET #0/SIB.

### Rasters in NR

In NR there are different rasters for RF channel and for synchronization channel (i.e. SSB). To simplify the initial cell search procedure in the UE, the SSB transmission in the base station can be configured only at predefined locations in the frequency domain. These possible locations in the frequency domain are called a synchronization raster.

This enables UE to tune its local oscillator only at one of the raster points at a time assuming it to be the frequency of the SSB being searched. The number of hypothesis used for the initial cell search therefore depends on the raster granularity or resolution i.e. frequency separation between any two successive raster points.

The frequency position of the SSB is defined as SS_{REF} (absolute frequency) with corresponding number called as Global Synchronization Channel Number (GSCN). The parameters defining the SS_{REF} and GSCN for all the frequency ranges are shown in table 1. The SS_{RE} identifies the resource element RE=#0 (subcarrier #0) of resource block RB #10 of the SSB (i.e. SSB comprising RB #0 to RB #19). This enables the UE to determine the entire location of the SSB since its numerology parameters (e.g. number of subcarriers, etc) are predefined. The range of GSCN, GSCN resolution (i.e. step size), SSB SCS etc are predefined for each frequency band. For example, for NR band n1 (2 GHz) the GSCN ranges from 5279 to 5419 with step size of 1; the SSB SCS for band n1 is 15 kHz.

TABLE 1
GSCN parameters for the synchronization
raster for different frequency ranges

| Frequency | | SS block frequency | | Range |
|---|---|---|---|---|
| range | | position SS_{REF} | GSCN | of GSCN |
| 0-3000 | MHz | N * 1200 kHz + M * 50 kHz, | 3N + | 2-7498 |
| | | N = 1:2499, M ϵ {1, 3, 5} (Note) | (M − 3)/2 | |
| 3000-24250 | MHz | 3000 MHz + N * 1.44 MHz | 7499 + N | 7499-22255 |
| | | N = 0:14756 | | |
| 24250-100000 | MHz | 24250.08 MHz + N * | 22256 + N | 22256-26639 |
| | | 17.28 MHz | | |
| | | N = 0:4383 | | |

### CGI Introduction

NR Cell Global Identifier (NCGI) is used to identify NR cells globally. The NCGI is constructed from the PLMN identity the cell belongs to and the NR Cell Identity (NCI) of the cell. The PLMN ID included in the NCGI should be the first PLMN ID within the set of PLMN IDs associated to the NR Cell Identity in SIB1, following the order of broadcast. NOTE: How to manage the scenario where a different PLMN ID has been allocated by the operator for an NCGI is left to OAM and/or implementation.

### CGI for Automatic Neighbour Cell Relation Function (ANR)

The purpose of ANR function is to relieve the operator from the burden of manually managing NCRs. The ANR function resides in the gNB and manages the Neighbour Cell Relation Table (NCRT). Located within ANR, the Neighbour Detection Function finds new neighbours and adds them to the NCRT. ANR also contains the Neighbour Removal Function which removes outdated NCRs. The Neighbour Detection Function and the Neighbour Removal Function are implementation specific.

An existing NCR from a source cell to a target cell means that gNB controlling the source cell:
a) Knows the global and physical IDs (e.g. NR CGI/NR PCI, ECGI/PCI) of the target cell; and
b) Has an entry in the NCRT for the source cell identifying the target cell; and
c) Has the attributes in this NCRT entry defined, either by OAM or set to default values.

NCRs are cell-to-cell relations, while an Xn link is set up between two gNBs. Neighbour Cell Relations are unidirectional, while an Xn link is bidirectional. NOTE: The neighbour information exchange, which occurs during the Xn Setup procedure or in the gNB Configuration Update procedure, may be used for ANR purpose.

The ANR function also allows OAM to manage the NCRT. OAM can add and delete NCRs. It can also change the attributes of the NCRT. The OAM system is informed about changes in the NCRT.

### CGI Reporting Procedure

The procedure for UE to report CGI is as follows.
if there is at least one applicable neighbouring cell to report:
   if the cell indicated by cellForWhichToReportCGI is an NR cell:
      if plmn-IdentityInfoList of the cgi-Info for the concerned cell has been obtained:
         include the plmn-IdentityInfoList including plmn-IdentityList, trackingAreaCode (if available), ranac (if available), cellIdentity and cellReservedForOperatorUse for each entry of the plmn-IdentityInfoList;
         include frequencyBandList if available;
      if nr-CGI-Reporting-NPN is supported by the UE and npn-IdentityInfoList of the cgi-Info for the concerned cell has been obtained:
         include the npn-IdentityInfoList including npn-IdentityList, trackingAreaCode, ranac (if available), cellIdentity and cellReservedForOperatorUse for each entry of the npn-IdentityInfoList;
      else if MIB indicates the SIB1 is not broadcast:
         include the noSIB1 including the ssb-SubcarrierOffset and pdcch-ConfigSIB1 obtained from MIB of the concerned cell;
   if the cell indicated by cellForWhichToReportCGI is an E-UTRA cell:
      if all mandatory fields of the cgi-Info-EPC for the concerned cell have been obtained:
         include in the cgi-Info-EPC the fields broadcasted in E-UTRA SystemInformationBlockType1 associated to EPC;
      if the UE is E-UTRA/5GC capable and all mandatory fields of the cgi-Info-5GC for the concerned cell have been obtained:
         include in the cgi-Info-5GC the fields broadcasted in E-UTRA SystemInformationBlockType1 associated to 5GC;
      if the mandatory present fields of the cgi-Info for the cell indicated by the cellForWhichToReportCGI in the associated measObject have been obtained:
         include the freqBandIndicator,
         if the cell broadcasts the multiBandInfoList, include the multiBandInfoList;
if the cell broadcasts the freqBandIndicatorPriority, include the freqBandIndicatorPriority;

### CGI Reading Requirement

The UE shall identify and report the CGI of a known NR target cell when requested by the network for the purpose of reportCGI. Only one cell is provided to the UE with cellForWhichToReportCGI for identifying the CGI. The UE may make autonomous gaps in both downlink reception and uplink transmission for receiving MIB and SIB1 message according to clause 5.5.3 of TS 38.331. Note that a UE is not required to use autonomous gap if useAutonomousGaps is set to false. If autonomous gaps are used for measurement with the purpose of reportCGI, regardless of whether DRX is used or not, or whether SCell(s) are configured or not, the UE shall be able to identify a new CGI of NR cell within:

$${I}_{identify \_ CGI} = ( {T}_{MIB} + {T}_{SIB 1} ) ms$$

Where:
   T_{MIB} is the time period used to acquire MIB message. T_{MIB}=6*T_{SMTC} ms for target cell carrier frequency on FR1 and T_{MIB}=25*T_{SMTC} ms for target cell carrier frequency on FR2.
   T_{SIB1} is the time period used to acquire SIB1 message. T_{SIB1}=6*T_{RMSI-scheduling} ms.
   Where T_{RMSI-scheduling} is the periodicity with which the SIB1 is transmitted by the NR target cell.

The requirement for identifying the CGI of an NR cell within Tidentify_CGI is applicable when no DRX is used as well as when any of the DRX cycles specified in TS 38.331 v16.6.0 is used.

### UE Measurements

The UE performs measurements on one or more DL and/or UL reference signal (RS) of one or more cells in different UE activity states e.g. RRC idle state, RRC inactive state, RRC connected state etc. The measured cell may belong to or operate on the same carrier frequency as of the serving cell (e.g. intra-frequency carrier) or it may belong to or operate on different carrier frequency as of the serving cell (e.g. non-serving carrier frequency). The non-serving carrier may be called as inter-frequency carrier if the serving and measured cells belong to the same RAT bit different carriers. The non-serving carrier may be called as inter-RAT carrier if the serving and measured cells belong to different RATs. Examples of downlink RS are signals in SSB, CSI-RS, CRS, DMRS, PSS, SSS, signals in SS/PBCH block (SSB), discovery reference signal (DRS), PRS etc. Examples of uplink RS are signals in SRS, DMRS etc.

Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms.

Examples of measurements are cell identification (e.g. PCI acquisition, PSS/SSS detection, cell detection, cell search etc), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc.

The UE is typically configured by the network (e.g. via RRC message) with measurement configuration and measurement reporting configuration e.g. measurement gap pattern, carrier frequency information, types of measurements (e.g. RSRP etc), higher layer filtering coefficient, time to trigger report, reporting mechanism (e.g. periodic, event triggered reporting, event triggered periodic reporting etc) etc.

The measurements are done for various purposes. Some example measurement purposes are: UE mobility (e.g. cell change, cell selection, cell reselection, handover, RRC connection re-establishment etc), UE positioning or location determination self-organizing network (SON), minimization of drive tests (MDT), operation and maintenance (O&M), network planning and optimization etc.

### Intra-Frequency Measurements

A measurement is defined as a SSB based intra-frequency measurement provided the centre frequency of the SSB of the serving cell indicated for measurement and the centre frequency of the SSB of the neighbour cell are the same, and the subcarrier spacing of the two SSBs are also the same.

The UE shall be able to identify new intra-frequency cells and perform SS-RSRP, SS-RSRQ, and SS-SINR measurements of identified intra-frequency cells if carrier frequency information is provided by PCell or the PSCell, even if no explicit neighbour list with physical layer cell identities is provided.

The UE can perform intra-frequency SSB based measurements without measurement gaps if:
the SSB is completely contained in the active BWP of the UE, or
the active downlink BWP is initial BWP.

For intra-frequency SSB based measurements without measurement gaps, UE may cause scheduling restriction as specified in clause 9.2.5.3 of TS38.133 v15.16.0.

SSB based measurements are configured along with one or two measurement timing configuration(s) (SMTC(s)) which provides periodicity, duration and offset information on a window of up to 5 ms where the measurements are to be performed. For intra-frequency connected mode measurements, up to two measurement window periodicities may be configured. A single measurement window offset and measurement duration are configured per intra-frequency measurement object.

### Intra-Frequency Cell Identification

The UE shall be able to identify a new detectable intra-frequency cell within T_{identify_intra_without_index} if UE is not indicated to report SSB based RRM measurement result with the associated SSB index (reportQuantityRsIndexes or maxNrofRSIndexesToReport is not configured), or the UE is indicated that the neighbour cell is synchronous with the serving cell (deriveSSB-IndexFromCell is enabled). Otherwise UE shall be able to identify a new detectable intra frequency cell within T_{identify_intra_with_index}. The UE shall be able to identify a new detectable intra frequency SS block of an already detected cell within T_{identify_intra_without_index}. It is assumed that deriveSSB-IndexFromCell is always enabled for FR1 TDD and FR2.

T_{identify_intra_without_index}=(T_{PSS/SSS_sync_intra}+T_{SSB_measurement_period_intra}) ms

T_{identify_intra_with_index}=(T_{PSS/SSS_sync_intra}+T_{SSB_measurement_period_intra}+T_{SSB_time_index_intra}) ms
Where:
   T_{PSS/SSS_sync_intra}: it is the time period used in PSS/SSS detection given in TS38.133 v15.16.0 table 9.2.5.1-1, 9.2.5.1-2, 9.2.5.1-4 (deactivated SCell) or 9.2.5.1-5 (deactivated SCell)
   T_{SSB_time_index_intra}: it is the time period used to acquire the index of the SSB being measured given in TS38.133 v15.16.0 table 9.2.5.1-3 or 9.2.5.1-6 (deactivated SCell)
   T_{SSB_measurement_period_intra}: equal to a measurement period of SSB based measurement given in TS 38.133 v15.16.0 table 9.2.5.2-1, table 9.2.5.2-2 table 9.2.5.2-3 (deactivated SCell) or 9.2.5.2-4 (deactivated SCell)

### Inter-Frequency Measurements

A measurement is defined as an SSB based inter-frequency measurement provided it is not defined as an intra-frequency measurement according to clause 9.2. The UE shall be able to identify new inter-frequency cells and perform SS-RSRP, SS-RSRQ, and SS-SINR measurements of identified inter-frequency cells if carrier frequency information is provided by PCell or PSCell, even if no explicit neighbour list with physical layer cell identities is provided.

SSB based measurements are configured along with a measurement timing configuration (SMTC) per carrier, which provides periodicity, duration and offset information on a window of up to 5 ms where the measurements on the configured inter-frequency carrier are to be performed. For inter-frequency connected mode measurements, one measurement window periodicity may be configured per inter-frequency measurement object.

When measurement gaps are needed, the UE is not expected to detect SSB on an inter-frequency measurement object which starts earlier than the gap starting time+switching time, nor detect SSB which ends later than the gap end-switching time. When the inter-frequency cells are in FR2 and the per-FR gap is configured to the UE in EN-DC, SA NR, NE-DC and NR-DC, or the serving cells are in FR2, the inter-frequency cells are in FR2 and the per-UE gap is configured to the UE in SA NR and NR-DC, the switching time is 0.25 ms. Otherwise, the switching time is 0.5 ms.

### Inter-Frequency Cell Identification

When measurement gaps are provided, or the UE supports capability of conducting such measurements without gaps, the UE shall be able to identify a new detectable inter frequency cell within T_{identify_inter_without_index} if UE is not indicated to report SSB based RRM measurement result with the associated SSB index (reportQuantityRsIndexes or maxNrofRSIndexesToReport is not configured). Otherwise UE shall be able to identify a new detectable inter frequency cell within T_{identify_inter_with_index}. The UE shall be able to identify a new detectable inter frequency SS block of an already detected cell within T_{identify_inter_without_index}.

T_{identify_inter_without_index}=(T_{PSS/SSS_sync_inter}+T_{SSB_measurement_period_inter}) ms

T_{identify_inter_with_index}=(T_{PSS/SSS_sync_inter}+T_{SSB_measurement_period_inter}+T_{SSB_time_index_inter}) ms
Where:
   T_{PSS/SSS_syno_inter}: it is the time period used in PSS/SSS detection given in TS38.133 v15.16.0 table 9.3.4-1 and table 9.3.4-2.
   T_{SSB_time_index_inter}: it is the time period used to acquire the index of the SSB being measured given in TS38.133 v15.16.0 table 9.3.4-3 and table 9.3.4-4.
   T_{SSB_measurement_period_inter}: equal to a measurement period of SSB based measurement given in TS38.133 v15.16.0 table 9.3.5-1 and table 9.3.5-2.

There currently exist certain challenge(s). For example, In Rel-15, a non-bandwidth reduced (non-BR) UE's measurement definition and configuration are basically based on CD-SSB. UE will also report the measurement results based on CD-SSB for default. From Rel-17, a new type of UE with bandwidth reduced (BR) (such as RedCap UE) is introduced. The main problem is that unlike legacy non-BR UE with CD-SSB as the reference frequency to perform measurements, the active BWP of BR UE may NOT include CD-SSB, but with NCD-SSB. If the definition of intra-frequency will follow the legacy definition, the NCD-SSB in target cell which has the same center frequency with the NCD-SSB in active BWP of serving cell may be believed as an inter-frequency and BR UE needs to perform measurements with measurement gaps. Thus, a new mechanism for adaptive reference frequency for measurements will be applied to BR UE.

Another important issue is that whether neighbour cell transmits the NCD-SSB is uncertain. Serving cell may not know the NCD-SSB status when serving cell plans to configure the BR UE to handover to the neighbour cell. Thus, UE needs to report the NCD-SSB status together with the measurement report for the target cell. When serving cell knows the measurement report for NCD-SSB, serving cell may ask BR UE to handover to the active BWP with NCD-SSB directly. Therefore, when BR UE reports the measurement results, network may also ask BR UE to report which type of SSB is used, CD-SSB or NCD-SSB.

NCD-SSB status is also an important information when network is configured to use ANR function to relieve the operator from the burden of manually managing NCRs. Thus, network may also ask UE to report NCD-SSB status together with CGI reporting

Certain aspects of the disclosure and their embodiments may provide solutions to these or other challenges. For example, in a first example embodiment, a network node indicates a reference frequency of a reference signal (RS) (e.g. ssb frequency such as ARFCN) to a UE e.g. BR UE. Both the network node and the UE (e.g. BR UE) will use this reference frequency to determine whether a measurement expected to be performed on the RS using or based on the reference frequency is an intra-frequency or inter-frequency measurement. The UE further determines based on the reference frequency whether the measurement will be performed with or without measurement gap. It is assumed that all UEs (e.g. BR UEs) in the same cell use the same type of receiver at a time.

In a second example embodiment, a UE is configured to perform one or more measurements on a RS (e.g. RS1 and/or RS2) based on indicated or configured reference frequency of RS1 and/or RS2) e.g. ssb frequency of CD-SSB and/or NCD-SSB). The UE is also indicated or configured to obtain information whether RS2 (e.g. NCD-SSB) is transmitted in target cell. The UE may be configured with any of the above configuration by receiving a message from a network node and/or based on a rule (e.g. pre-defined information). The UE performs one or more measurements based on the configuration. The UE may obtain the information about RS2 based on one or more of mechanisms e.g. by acquiring the SI (which transmits RS2 information) of the target cell (e.g. using autonomous gaps), by blindly detecting the RS2 in the target cell etc. The UE uses the performed measurements and/or obtained RS2 information for performing one or more operational tasks e.g.:
In a specific example, UE reports one or more of the following to a network node:
   signal measurements (e.g. RSRP, RSRQ etc) along with the type of RS (e.g. SSB such as CD-SSB and/or NCD-SSB) used for performing the reported measurements e.g. reports the measurement result along with the RS type on which the measurement is done.
   Obtained information about the RS2 in the target cell.
In another specific example, UE uses the one or more of following for logging e.g. for MDT purpose:
   signal measurements (e.g. RSRP, RSRQ etc) along with the type of RS (e.g. SSB such as CD-SSB and/or NCD-SSB) used for performing the reported measurements e.g. reports the measurement result along with the RS type on which the measurement is done.
   Obtained information about the RS2 in the target cell.

In a third example embodiment, a UE is indicated or configured to acquire CGI for a target cell. The UE can also be indicated or configured to report whether the RS2 (e.g. NCD-SSB) is transmitted in the target cell. The UE can also be indicated or configured to use the acquired CGI and/or the RS2 information for one or more operational tasks e.g. for reporting the acquired CGI and/or the RS2 information to the network node, for logging the acquired CGI and/or the RS2 information etc. The UE may be configured to acquire CGI and/or request for acquiring RS2 by receiving a message from a network node and/or based on a rule (e.g. pre-defined information). The UE acquires CGI and the information about RS2 in the target cell and use them for one or more operational tasks. The UE may obtain the information about RS2 based on one or more of mechanisms e.g. by acquiring the SI (which transmits RS2 information) of the target cell (e.g. using autonomous gaps), by blindly detecting the RS2 in the target cell etc.

Examples of signal strength measurements are path loss, RSRP etc. Examples of RSRP are SS-RSRP, SSB based L1-RSRP, CSI-RS based L1-RSRP, PRS-RSRP, SSB-based L1-SINR, CSI-RS based L1-SINR, etc.

A signal strength measurement is performed by a UE on a reference signal (RS) transmitted by a cell. Examples of RS are SSB etc. Examples of RS1 and RS2 are CD-SSB and NCD-SSB respectively. RS1 and RS2 differ in terms of at least one property in the frequency domain e.g. RS1 is transmitted on synchronization raster while RS2 is not transmitted on synchronization raster.

### SUMMARY

Certain example embodiments of this disclosure may provide one or more of the following technical advantage(s). For example, the bandwidth-reduced (BR) User Equipment (UE) and non-BR UE measurement behavior is well defined when NCD-SSB transmission is configured. Additionally or alternatively, for example, example embodiments may guarantee the handover, Self-Organizing Networks (SON) performance for both network and BR UE.

A first example aspect of this disclosure provides a method in a network node of determining a configuration of a User Equipment (UE) to perform a measurement on a second cell, wherein the UE is served by a first cell. The method comprises determining whether the measurement is an inter-frequency measurement or an intra-frequency measurement based on a frequency of a first reference signal on the first cell and a frequency of a first reference signal on the second cell; and determining whether the measurement is to be performed with or without a measurement gap based on the frequency of the first reference signal on the second cell and based on: (i) the frequency of the first reference signal on the first cell or a frequency of a second reference signal on the first cell; and/or (ii) an active bandwidth part (BWP) of the UE on the first cell.

Another example aspect of this disclosure provides a method in a User Equipment (UE) of determining a configuration of a measurement on a second cell, wherein the UE is served by a first cell. The method comprises determining whether the measurement is an inter-frequency measurement or an intra-frequency measurement based on a frequency of a first reference signal on the first cell and a frequency of a first reference signal on the second cell; and determining whether the measurement is to be performed with or without a measurement gap based on the frequency of the first reference signal on the second cell and based on: (i) the frequency of the first reference signal on the first cell or a frequency of a second reference signal on the first cell; and/or (ii) an active bandwidth part (BWP) of the UE on the first cell.

A further example aspect of this disclosure provides a method in a network node of receiving a report from a User Equipment (UE), wherein the UE is served by a first cell and the report is associated with a second cell. The method comprises receiving a report from the UE, wherein the report indicates whether a non-cell-defining synchronization signal block (NCD-SSB) is being broadcast on the second cell.

Another example aspect of this disclosure provides a method in a User Equipment (UE) of sending a report to a network node, wherein the UE is served by a first cell and the report is associated with a second cell. The method comprises sending a report to the network node, wherein the report indicates whether a non-cell-defining synchronization signal block (NCD-SSB) is being broadcast on the second cell.

A still further example aspect of this disclosure provides a method in a network node of receiving a report from a User Equipment (UE), wherein the UE is served by a first cell and the report is associated with a second cell. The method comprises receiving a report from the UE, wherein the report indicates whether a second reference signal is being transmitted in the second cell or the report indicates whether the report is associated with the second reference signal or with a first reference signal.

Another example aspect of this disclosure provides a method in a User Equipment (UE) of sending a report to a network node, wherein the UE is served by a first cell and the report is associated with a second cell. The method comprises sending a report to the network node, wherein the report indicates whether a second reference signal is being transmitted in the second cell or the report indicates whether the report is associated with the second reference signal or with a first reference signal.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows an example of a SSB time-frequency structure;

FIG. 2 depicts an example of a method in a User Equipment (UE) of determining a configuration of a measurement on a second cell in accordance with particular embodiments;

FIG. 3 depicts an example of a method in a network node of determining a configuration of a User Equipment (UE) to perform a measurement on a second cell in accordance with particular embodiments;

FIG. 4 depicts an example of a method in network node of receiving a report from a User Equipment (UE) in accordance with particular embodiments;

FIG. 5 depicts an example of a method in a User Equipment (UE) of sending a report to a network node in accordance with particular embodiments;

FIG. 6 depicts an example of a method in network node of receiving a report from a User Equipment (UE) in accordance with particular embodiments;

FIG. 7 depicts an example of a method in a User Equipment (UE) of sending a report to a network node in accordance with particular embodiments;

FIG. 8 shows an example of one UE and one BR UE served in a serving cell for CGI reading of a neighbour cell;

FIG. 9 shows an example of the relation between BR UE and SSB;

FIG. 10 shows another example of the relation between BR UE and SSB;

FIG. 11 shows another example of the relation between BR UE and SSB;

FIG. 12 shows an example of UE searching NCD-SSB with a step equaling f1 Hz;

FIG. 13 shows an example of a communication system in accordance with some embodiments;

FIG. 14 shows a UE in accordance with some embodiments;

FIG. 15 shows a network node in accordance with some embodiments;

FIG. 16 is a block diagram of a host in accordance with various aspects described herein;

FIG. 17 is a block diagram illustrating a virtualization environment in which functions implemented by some embodiments may be virtualized; and

FIG. 18 shows a communication diagram of a host communicating via a network node with a UE over a partially wireless connection in accordance with some embodiments.

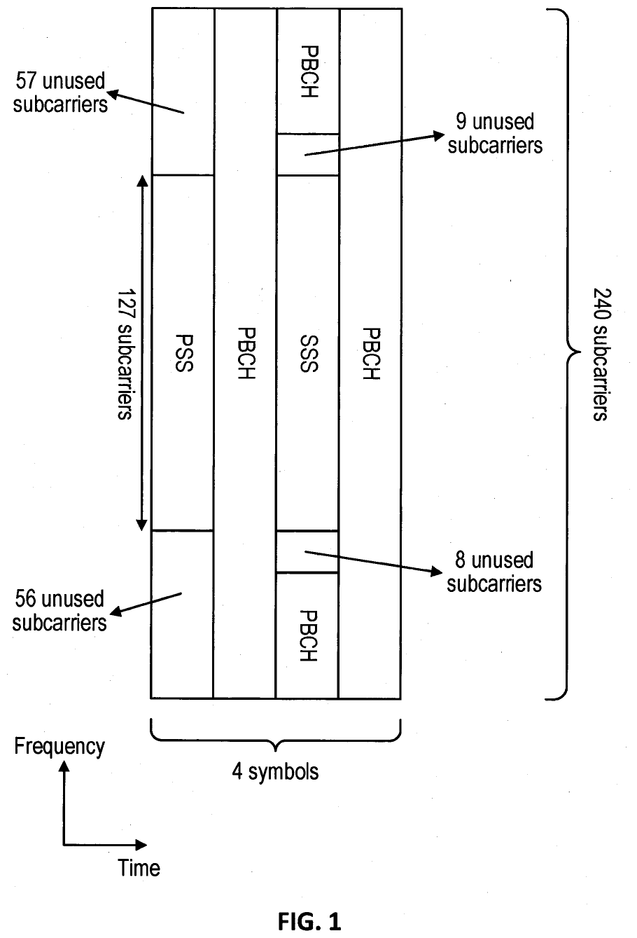

### DETAILED DESCRIPTION

Some of the embodiments contemplated herein will now be described more fully with reference to the accompanying drawings. Embodiments are provided by way of example to convey the scope of the subject matter to those skilled in the art.

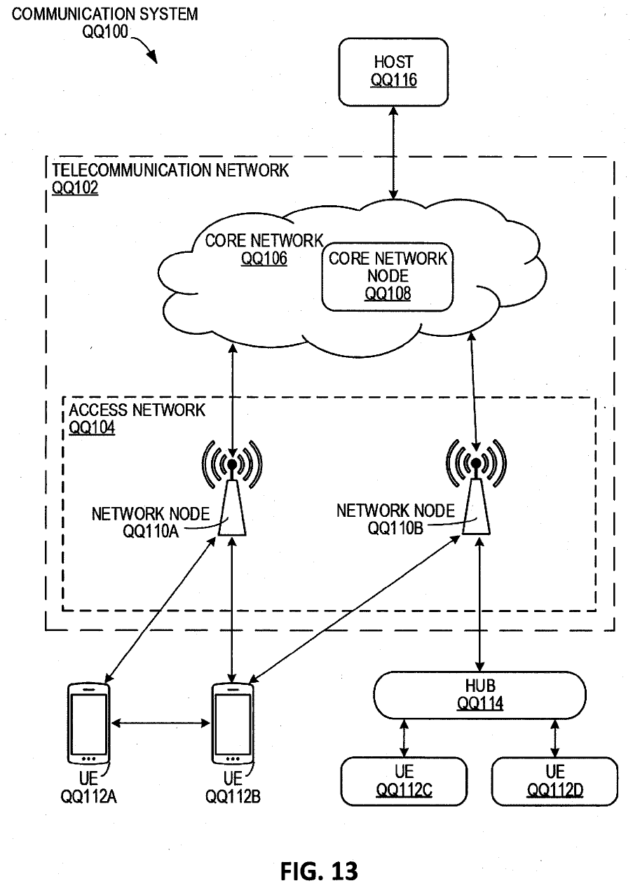

FIG. 2 depicts an example of a method 200 in a network node of determining a configuration of a User Equipment (UE) to perform a measurement on a second cell in accordance with particular embodiments. The method 200 may be performed by a network node (e.g. the network node QQ110 or network node QQ300 as described later with reference to FIGS. 13 and 15 respectively). The method begins at step 202 with determining whether the measurement is an inter-frequency measurement or an intra-frequency measurement based on a reference frequency and a frequency of a reference signal on the second cell, wherein the reference frequency comprises a frequency of a reference signal of an active bandwidth part (BWP) of the UE.

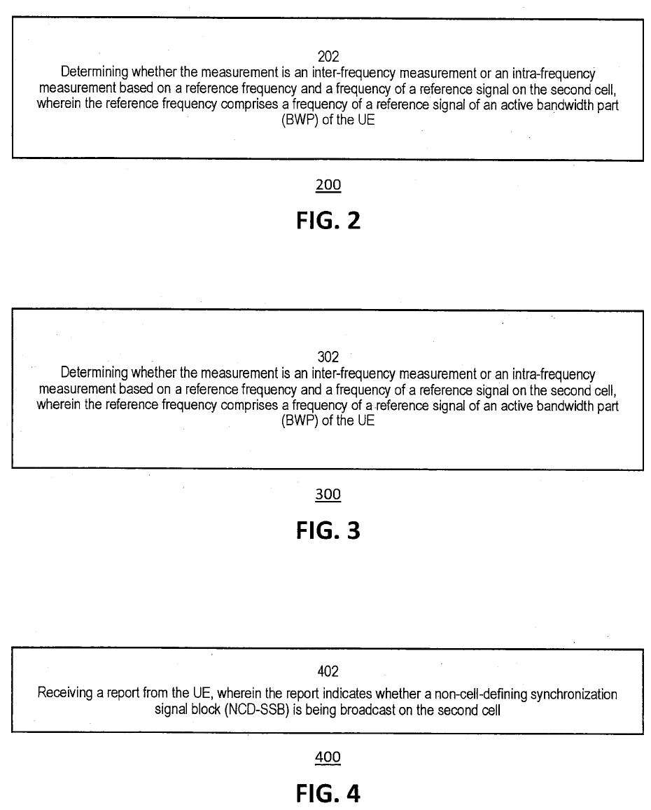

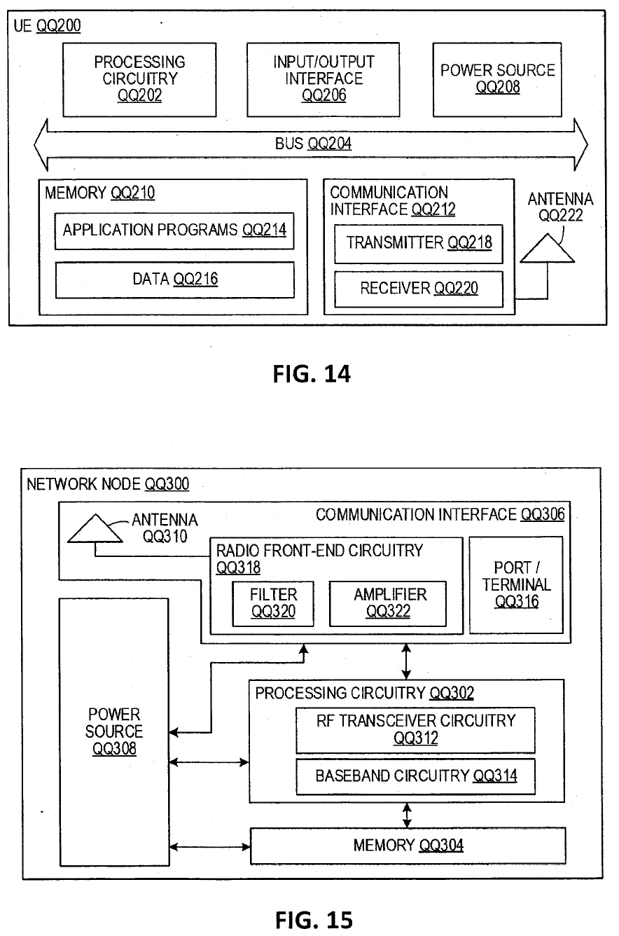

FIG. 3 depicts an example of a method 300 in a User Equipment (UE) of determining a configuration of a measurement on a second cell in accordance with particular embodiments. The method 300 may be performed by a UE or wireless device (e.g. the UE QQ112 or UE QQ200 as described later with reference to FIGS. 13 and 14 respectively). The method begins at step 302 with determining whether the measurement is an inter-frequency measurement or an intra-frequency measurement based on a reference frequency and a frequency of a reference signal on the second cell, wherein the reference frequency comprises a frequency of a reference signal of an active bandwidth part (BWP) of the UE.

FIG. 4 depicts an example of a method 400 in network node of receiving a report from a User Equipment (UE) in accordance with particular embodiments, wherein the UE is served by a first cell and the report is associated with a second cell. The method 400 may be performed by a network node (e.g. the network node QQ110 or network node QQ300 as described later with reference to FIGS. 13 and 15 respectively). The method begins at step 402 with receiving a report from the UE, wherein the report indicates whether a non-cell-defining synchronization signal block (NCD-SSB) is being broadcast on the second cell.

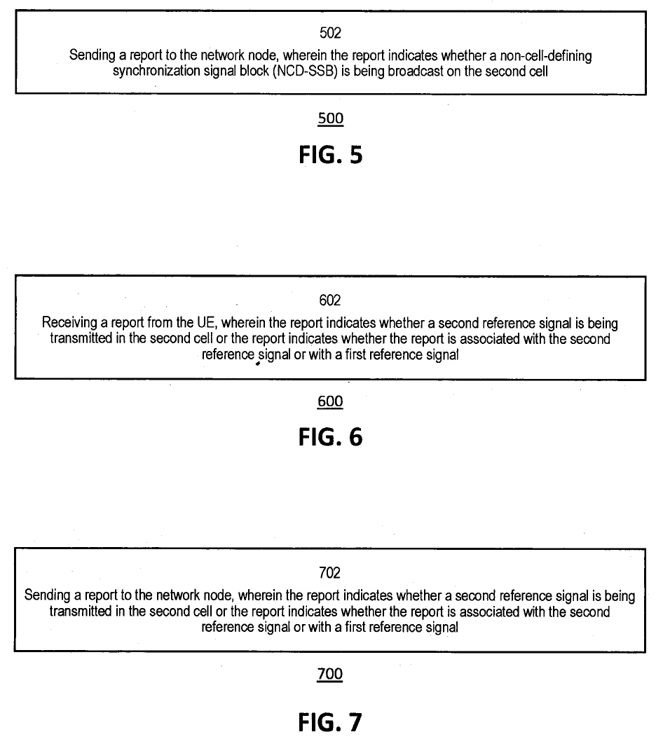

FIG. 5 depicts an example of a method 500 in a User Equipment (UE) of sending a report to a network node in accordance with particular embodiments, wherein the UE is served by a first cell and the report is associated with a second cell. The method 500 may be performed by a UE or wireless device (e.g. the UE QQ112 or UE QQ200 as described later with reference to FIGS. 13 and 14 respectively). The method begins at step 502 with sending a report to the network node, wherein the report indicates whether a non-cell-defining synchronization signal block (NCD-SSB) is being broadcast on the second cell.

FIG. 6 depicts an example of a method 600 in network node of receiving a report from a User Equipment (UE) in accordance with particular embodiments, wherein the UE is served by a first cell and the report is associated with a second cell. The method 600 may be performed by a network node (e.g. the network node QQ110 or network node QQ300 as described later with reference to FIGS. 13 and 15 respectively). The method begins at step 602 with receiving a report from the UE, wherein the report indicates whether a second reference signal is being transmitted in the second cell or the report indicates whether the report is associated with the second reference signal or with a first reference signal.

FIG. 9 depicts an example of a method 700 in a User Equipment (UE) of sending a report to a network node in accordance with particular embodiments, wherein the UE is served by a first cell and the report is associated with a second cell. The method 700 may be performed by a UE or wireless device (e.g. the UE QQ112 or UE QQ200 as described later with reference to FIGS. 13 and 14 respectively). The method begins at step 702 with sending a report to the network node, wherein the report indicates whether a second reference signal is being transmitted in the second cell or the report indicates whether the report is associated with the second reference signal or with a first reference signal.

Particular example embodiments are now described.

In this disclosure, a term “node” is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc. The non-limiting term User Equipment (UE) refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-loT), WiFi, Bluetooth, next generation RAT, New Radio (NR), 4G, 5G, etc. Any of the equipment denoted by the term node, network node or radio network node may be capable of supporting a single or multiple RATs. The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH. sPUCCH. sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are: symbol, sub-slot, mini-slot, time slot, subframe, radio frame, TTI, interleaving time, frame, SFN cycle, hyper-SFN cycle, etc.

### General Aspects Common to Multiple Embodiments

In certain embodiments, such as for example the specific example embodiments described below, the scenario comprises of a UE served by a first cell (cell1) is configured to perform a measurement on a first reference signal (RS1) transmitted by a second cell (cell2). Cell2 may also transmit a second reference signal (RS2). The relation or differences between RS1 and RS2 are as follows:
The frequencies over which RS1 and RS2 are transmitted are not identical e.g.
   In one example the center frequencies of RS1 and RS2 are different.
   In another example the starting points of frequencies (in frequency domain) of RS1 and RS2 are different.
   In another example the ending points of frequencies (in frequency domain) of RS1 and RS2 are different.
   The magnitude of any of the above differences in frequency domain may be larger than the magnitude of the frequency error e.g. larger than 0.1 ppm.
   In one example RS1 is transmitting on a synchronization raster while RS2 is not transmitting on a synchronization raster.
For performing some procedures any of the RS1 and RS2 may be used by the UE e.g. for performing signal measurements such as cell search RSRP, RSRQ etc.
For performing some procedures the UE can use only RS1 and not RS2. For example the UE can use only RS1 for performing initial cell search or cell selection.
For performing some procedures the UE can use only RS2 and not RS1. For example the UE may be explicitly configured to perform certain measurements on RS2 e.g. based on receive indication from the network node or based on a pre-defined rule.
The RS1 and RS2 may be transmitting in partially or fully overlapping time resources in time or they may be transmitted in non-overlapping time resources in time.
The UE may be configured with different BWPs (BWP1 and BWP2) associated with RS1 and RS2 respectively.
Examples of RS1 and RS2 are given below:
   In one example, RS1 and RS2 are different SSBs e.g. a first SSB (SSB1) and a second SSB (SSB2) respectively.
   In another example, RS1 and RS2 are CD-SSB and NCD-SSB respectively.
   In another example, RS1 and RS2 are CSI-RS and NCD-SSB respectively.

### Embodiment #1: Method in a NW of Configuring Measurements Based on Reporting RS2 (e.g. NCD-SSB) Information in the UE

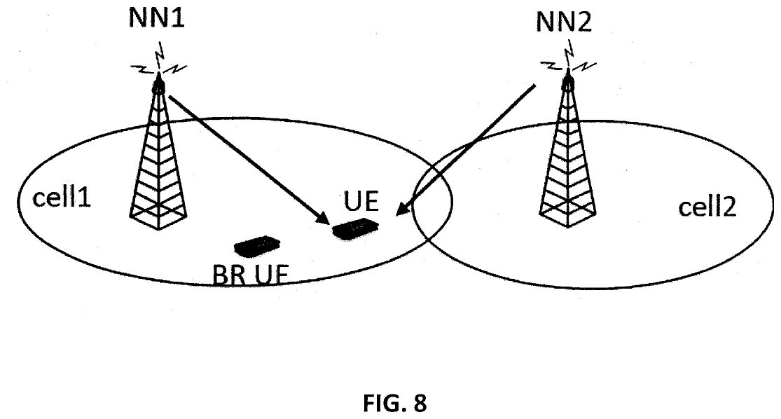

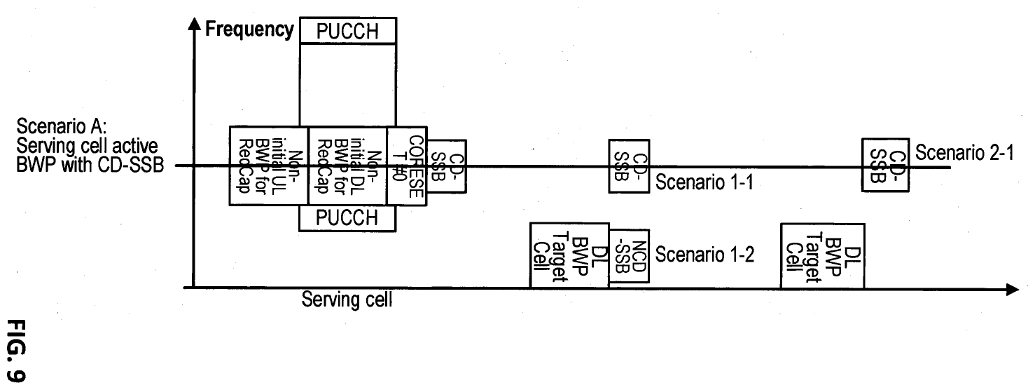

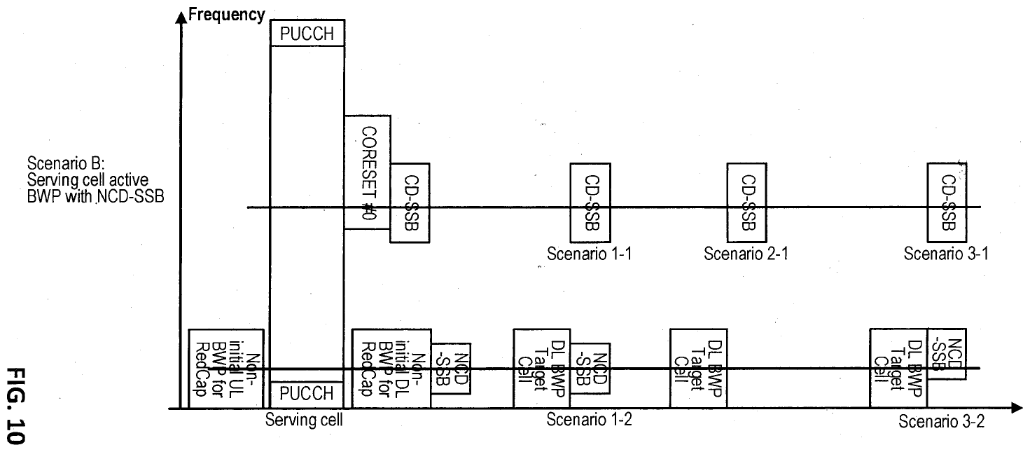

This embodiment, the scenario comprises of a UE (e.g. BR UE) served by a first cell (cell1) which is managed by a first network node (NN1), and there is a second cell (cell2) being measured by the UE e.g. BR UE. An example of the scenario is shown in FIG. 8, which shows an example of one UE and one BR UE served in a serving cell for CGI reading of a neighbour cell. There are several specific scenarios for cell2 measurements as follows.
Scenario A: the active BWP of UE (e.g. BR UE) includes RS1 e.g. CD-SSB
Scenario B: the active BWP of BR UE includes RS2 (e.g. NCD-SSB), RS1 (e.g. CD-SSB) is out of active BWP
Scenario C: the active BWP of UE (e.g. BR UE) doesn't include RS2 (e.g. NCD-SSB, and RS1 (e.g. CD-SSB) is out of active BWP

For Scenario A, FIG. 9 shows an example of the relation between BR UE and SSB (active BWP includes CD-SSB).

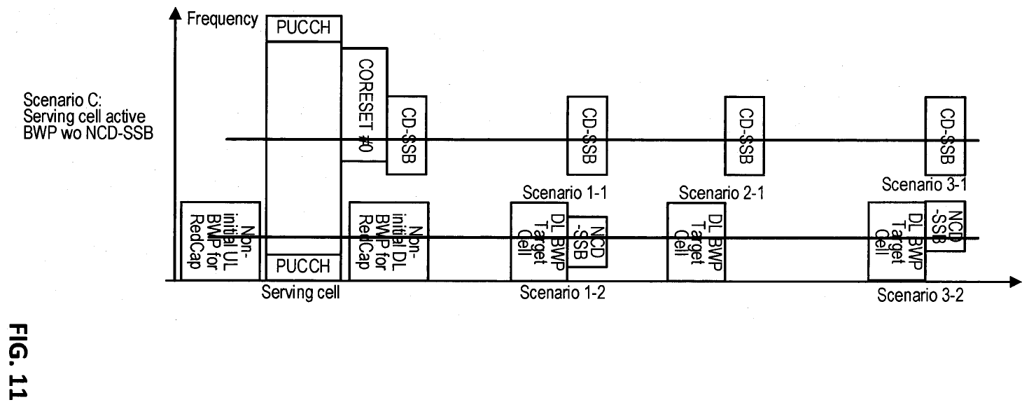

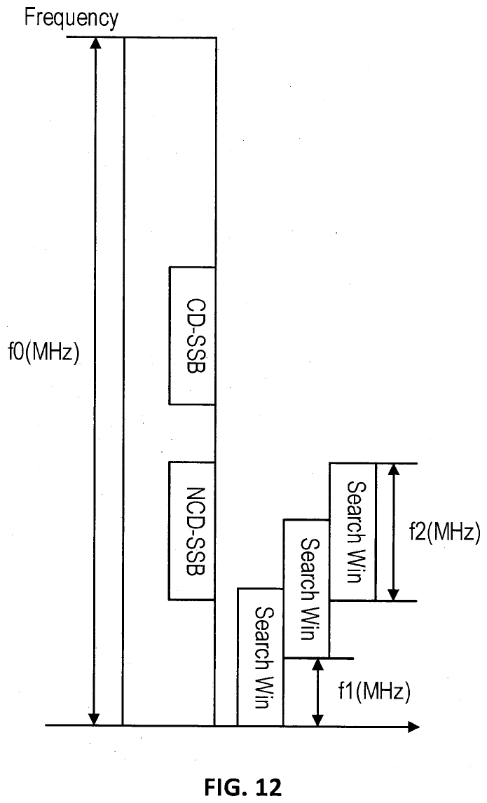

For scenario B, FIG. 10 shows an example of the relation between BR UE and SSB (active BWP includes NCD-SSB).

For Scenario B, FIG. 11 shows an example of the relation between BR UE and SSB (active BWP without SSB).

In one general example, the network (NW) will configure the reference RS (RS1 or RS2) (e.g. reference SSB) (CD-SB or NCD-SSB) to perform measurement. A new element could be added in IE MeasConfig as the following way (additions in bold):

-- ASN1START
-- TAG-MEASCONFIG-START

| | |
|---|---|
| MeasConfig ::= | SEQUENCE { |

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
    ...,
    [[
```

| | |
|---|---|
| interFrequencyConfig-NoGap-r16 | ENUMERATED {true} |

```
OPTIONAL -- Need R
    ]],
  [[
```

| | |
|---|---|
| s-MeasureReferenceConfig-r17 | ENUMERATED {CD-SSB, NCD-SSB} |

```
  OPTIONAL, -- Need RedCap
  ]]
  }
```

UE will use the reference RS (RS1 or RS2) (e.g. reference SSB) to determine whether carrier frequency on which the reference RS is transmitted is the intra- and inter-frequency.
In one specific example, Scenario A, NN1 configures RS1 (e.g. CD-SSB) as the reference frequency.
   In sub-scenario 1-1, the measurement is defined as intra-frequency without gap.
   In sub-scenario 1-2, the measurement is defined as inter-frequency with gap.
   In sub-scenario 2-1, the measurement is defined as intra-frequency without 50 gap.
In one specific example, Scenario B, NN1 configures RS1 (e.g. CD-SSB) as the reference frequency.
   In sub-scenario 1-1, 2-1, 3-1 the measurement is defined as intra-frequency with gap.
   In sub-scenario 1-2, the measurement is defined as inter-frequency measurement.
      In one example, UE can perform this inter-frequency measurement without gap without any capability because the SSB frequency for target cell is the same as NCD-SSB frequency in serving cell active BWP.
      In one example, UE can perform this inter-frequency measurement without gap with capability reporting as ‘interFrequencyMeas-NoGap-r16’.
   In sub-scenario 3-2, the measurement is defined as inter-frequency measurement.
      In one example, UE can perform this inter-frequency measurement without gap without any capability because the SSB frequency for target cell is in serving cell active BWP.
      In another example, UE can perform this inter-frequency measurement without gap with capability reporting as ‘interFrequencyMeas-NoGap-r16’.
      In another example, UE can perform this inter-frequency measurement with gap.
In one specific example, Scenario B, NN1 configures RS2 (e.g. NCD-SSB) as the reference frequency.
   In sub-scenario 1-1, 2-1, 3-1 the measurement is defined as inter-frequency with gap.
   In sub-scenario 1-2, the measurement is defined as intra-frequency without gap.
   In sub-scenario 3-2, the measurement is defined as inter-frequency. The definition is the same as Scenario B, NN1 configures CD-SSB as the reference frequency.
In one specific example, Scenario C, NN1 configures RS1 (e.g. CD-SSB) as the reference frequency.
   In sub-scenario 1-1, 2-1, 3-1 the measurement is defined as intra-frequency with gap.
   In sub-scenario 1-2, the measurement is defined as inter-frequency measurement.
      In one example, UE can perform this inter-frequency measurement without gap without any capability because the SSB frequency for target cell is in serving cell active BWP.
      In another example, UE can perform this inter-frequency measurement without gap with capability reporting as ‘interFrequencyMeas-NoGap-r16’.
      In another example, UE can perform this inter-frequency measurement with gap.
   In sub-scenario 3-2, the measurement is defined as inter-frequency. The definition is the same as Scenario B, NN1 configures CD-SSB as the reference frequency.

In another general example, both NW and UE will determine whether carrier frequency is the intra- and inter-frequency based on RS2 (e.g. NCD-SSB) if there is an RS2 (e.g. NCD-SSB) transmission in a specific active BWP of serving cell. Otherwise, both NW and UE will determine whether carrier frequency is the intra- and inter-frequency based on RS1 (e.g. CD-SSB).
In one specific example, Scenario A, the intra-frequency definition is based on RS1 (e.g. CD-SSB) as the reference frequency. The definition is the same as Scenario A above.
In one specific example, Scenario B, the intra-frequency definition is based on RS2 (e.g. NCD-SSB) as the reference frequency. The definition is the same as Scenario B, NW configuring RS2 (e.g. NCD-SSB) as the reference frequency above.
In one specific example, Scenario C, the intra-frequency definition is based on RS1 (e.g. CD-SSB) as the reference frequency. The definition is the same as Scenario C above.

In another general example, both NW and UE will determine whether carrier frequency is the intra- and inter-frequency only based on RS1 (e.g. CD-SSB).
In one specific example, Scenario A, the intra-frequency definition is based on RS1 (e.g. CD-SSB) as the reference frequency. The definition is the same as Scenario A above.
In one specific example, Scenario B, the intra-frequency definition is based on RS1 (e.g. CD-SSB) as the reference frequency. The definition is the same as Scenario B, NW configuring RS1 (e.g. CD-SSB) as the reference frequency above.
In one specific example, Scenario C, the intra-frequency definition or determination is based on RS1 (e.g. CD-SSB) as the reference frequency. The definition is the same as Scenario C above.

### Embodiment #2: Method in a UE of Reporting RS2 (e.g. NCD-SSB) Information with Measurement Reporting

This embodiment scenario comprises of a UE (e.g. which can be BR UE or a non-BR UE) served by a first cell (cell1) which is managed by a first network node (NN1), and there is a second cell (cell2) being measured by the UE (e.g. BR UE or a non-BR UE).

In one general example, the UE (e.g. BR UE) is configured to perform a measurement (e.g. the signal strength (e.g. RSRP, path loss etc.) and/or signal quality (e.g. RSRQ, RSSI, SINR etc) of cell2. The UE may be configured to perform measurement on a first reference signal (RS1) of cell2 e.g. on CD-SSB indicated by ssb frequency of the CD-SSB, CSI-RS etc. The UE is further configured to obtain information whether a second reference signal (RS2) (e.g. NCD-SSB) is transmitted in cell2 by NN1.

In one example the UE is autonomously configured (e.g. decided by the UE itself) to obtain the information whether RS2 is transmitted in cell2 or not. In another example the UE is configured by the network node (e.g. by NN1) to obtain the information whether RS2 is transmitted in cell2 or not.

In one specific example, the UE may be configured by NN1 to obtain the information about RS2 in cell2 as part of specific measurement procedure e.g. measurement procedure which requires the UE to acquire at least the SI of cell2.

One specific example of such measurement procedure is acquisition of CGI of cell2. In one specific example the UE additionally detects or determines whether RS2 (e.g. NCD-SSB) is transmitted in cell2 based on cell1's indication or request. A new element could be added in IE ReportConfigNR as the following way (additions in bold):

| | |
|---|---|
| PeriodicalReportConfig ::= | SEQUENCE { |
| rsType | NR-RS-Type, |
| reportInterval | ReportInterval, |
| reportAmount | ENUMERATED {r1, r2, r4, r8, r16, |

r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| useWhiteCellList | BOOLEAN, |

```
    ...,
    [[
```

| | |
|---|---|
| measRSSI-ReportConfig-r16 | MeasRSSI-ReportConfig-r16 |

OPTIONAL, -- Need R

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList- |
| r16} | OPTIONAL, -- Need M |
| ul-DelayValueConfig-r16 | SetupRelease { UL- |
| DelayValueConfig-r16 } | OPTIONAL, -- Need M |
| reportAddNeighMeas-r16 | ENUMERATED {setup} |

```
OPTIONAL -- Need R
    ]],
  [[
```

| | |
|---|---|
| reportQuantityRS-Type-r17 | ENUMERATED {CD-SSB, NCD- |

SSB}
OPTIONAL, -- Need RedCap
]]
}

The information about the RS2 may also be called as RS2 configuration in cell2. In one example, the RS2 configuration identifies the time-frequency resource or location over which RS2 is transmitted in cell2. In one specific example, RS2 configuration may comprise at least frequency information which identifies the frequency location of RS2 e.g. within the cell BW. The frequency information may comprise for example a frequency channel number (e.g. ARFCN) and/or a frequency offset wrt reference point (e.g. edge, end or center of cell BW in frequency). Examples of the frequency location of RS2 are starting frequency, center frequency or last frequency of RS2 in frequency domain. The RS2 configuration may further comprise timing which identifies time location or time duration during which the RS2 is transmitted in cell2. Examples of timing information are RS2 index in time (e.g. NCD-SSB index), reference time identifying the starting time of time resource containing RS2, reference time identifying the ending time of time resource containing RS2 etc. Reference time may comprise one or more of SFN, subframe, slot, symbols etc. A specific example of reference time starting time of NCD-SSB is symbol #X1, slot #X2 and SFN #X3.

The UE may further be configured to use the obtained information about RS2 for performing one or more radio operational tasks. Examples of tasks are:
Transmitting the obtained information about the RS2 (e.g. NCD-SSB) in cell2 to a network node e.g. to NN1.
Using the obtained information about the RS2 (e.g. NCD-SSB) in cell2 for performing cell change to cell2 e.g. in low activity RRC state (e.g. idle or inactive state) etc.
Storing the obtained information about the RS2 (e.g. NCD-SSB) in cell2 and using it for one or more tasks in future time e.g. logging it as part of SON, MDT or ANR procedure. The logged information may further comprise timing when and/or geographical location where the information about the RS2 is logged by the UE. The UE may transmit the logged information to a network node (e.g. to NN1 or to another network node) when the UE RRC state changes to high activity RRC state (e.g. RRC connected state) and/or after configured logging time period.

The following section provides several examples on how the UE can obtain the RS2 configuration information (e.g. NCD-SSB configuration) in cell2 and use it for one or more operational tasks:

Obtaining RS2 Configuration (e.g. NCD-SSB Configuration) by Acquiring the SI of Cell2:

In one example, the UE obtains the RS2 configuration in cell2 by acquiring or receiving or reading the system information (SI) (e.g. MIB, SIB1 etc) of cell2. This mechanism may be applied if the information about the RS2 configuration (e.g. ARFCN, NCD-SSB index etc) is transmitted by cell2 in its SI information.

The UE may create autonomous gaps to acquire all necessary components of cell2's SI (e.g. MIB, SIB1 etc) whose acquisition is required to obtain the RS2 configuration. In one example some or all RS2 configuration information is transmitted in a SIB e.g. in SIB1. In another example some or all RS2 configuration information is transmitted in a MIB.

In one example, the UE obtains the RS2 configuration in cell2 whenever the UE is explicitly requested to do so. In another example, the UE obtains the RS2 configuration in cell2 whenever the UE has to acquire SI of cell2 e.g. when requested to acquire the CGI of cell2, when acquiring the SI of cell2 during cell change procedure (e.g. cell reselection to cell2). In another example, the UE obtains the RS2 configuration in cell2 autonomously or proactively.

Below are some examples regarding how such information can be provided in SIB1:

### SIB1

SIB1 contains information relevant when evaluating if a UE is allowed to access a cell and defines the scheduling of other system information. It also contains radio resource configuration information that is common for all UEs and barring information applied to the unified access control.
Signalling radio bearer: N/A
RLC-SAP: TM
Logical channels: BCCH
Direction: Network to UE

### SIB1 Message

-- ASN1START
-- TAG-SIB1-START
SIB1 ::= SEQUENCE {

| | |
|---|---|
| cellSelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S
}
OPTIONAL, -- Cond Standalone

| | |
|---|---|
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC- |

```
AccessCategory1-SelectionAssistanceInfo
    }
OPTIONAL -- Need S
  }
OPTIONAL, -- Need R
```

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL,
}

| | |
|---|---|
| SIB1-v1610-IEs ::= | SEQUENCE { |
| idleModeMeasurementsEUTRA-r16 | ENUMERATED{true} |

OPTIONAL, -- Need R

| | |
|---|---|
| idleModeMeasurementsRS-r16 | ENUMERATED{true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | [symbol] SIB1-v1700-IEs |

OPTIONAL
},

| | |
|---|---|
| SIB1-v1700-IEs ::= | SEQUENCE { |
| q-RxLevMin-NCD-r17 | Q-RxLevMin |

OPTIONAL,

| | |
|---|---|
| nonCriticalExtension | SEQUENCE ( ) |

OPTIONAL
}
uac-AccessCategory1-SelectionAssistanceInfo ::= ENUMERATED {a, b, c}
-- TAG-SIB1-STOP
-- ASN1STOP

One alternative can be to add a new parameter q-RxLevMin-NCD, with the description below:

SIB1 field descriptions

cellSelectionInfo
Parameters for cell selection related to the serving cell.
eCallOverIMS-Support
Indicates whether the cell supports eCall over IMS services as defined in TS 23.501 [32]. If
absent, eCall over IMS is not supported by the network in the cell.
idleModeMeasurementsEUTRA
This field indicates that a UE that is configured for EUTRA idle/inactive measurements shall
perform the measurements while camping in this cell and report availability of these
measurements when establishing or resuming a connection in this cell. If absent, a UE is not
required to perform EUTRA idle/inactive measurements.
idleModeMeasurementsNR
This field indicates that a UE that is configured for NR idle/inactive measurements shall perform
the measurements while camping in this cell and report availability of these measurements when
establishing or resuming a connection in this cell. If absent, a UE is not required to perform NR
idle/inactive measurements.
ims-EmergencySupport
Indicates whether the cell supports IMS emergency bearer services for UEs in limited service
mode. If absent, IMS emergency call is not supported by the network in the cell for UEs in limited
service mode.
q-QualMin
Parameter “Q_{qualmin}” in TS 38.304 [20], applicable for serving cell. If the field is absent, the UE
applies the (default) value of negative infinity for Q_{qualmin}.
q-QualMinOffset
Parameter “Q_{qualminoffset}” in TS 38.304 [20]. Actual value Q_{qualminoffset} = field value [dB]. If the field is
absent, the UE applies the (default) value of 0 dB for Q_{qualminoffset}. Affects the minimum required
quality level in the cell.
q-RxLevMin
Parameter “_{Qrxlevmin}” in TS 38.304 [20], applicable for serving cell.
q-RxLevMin-NCD
Parameter “_{Qrxlevmin}-NCD” in TS 38.304 [20], applicable for serving cell.
q-RxLevMinOffset
Parameter “_{Qrxlevminoffset}” in TS 38.304 [20]. Actual value Q_{rxlevminoffset} = field value * 2 [dB]. If absent,
the UE applies the (default) value of 0 dB for Q_{rxlevminoffset}. Affects the minimum required Rx level
in the cell.
q-RxLevMinSUL
Parameter “_{Qrxlevmin}” in TS 38.304 [20], applicable for serving cell.
servingCellConfigCommon
Configuration of the serving cell.
uac-AccessCategory1-SelectionAssistanceInfo
Information used to determine whether Access Category 1 applies to the UE, as defined in TS
22.261 [25].
uac-BarringForCommon
Common access control parameters for each access category. Common values are used for all
PLMNs, unless overwritten by the PLMN specific configuration provided in uac-BarringPerPLMN-
List. The parameters are specified by providing an index to the set of configurations (uac-
BarringInfoSetList). UE behaviour upon absence of this field is specified in clause 5.3.14.2.
ue-TimersAndConstants
Timer and constant values to be used by the UE. The cell operating as PCell always provides this
field.
useFullResumeID
Indicates which resume identifier and Resume request message should be used. UE uses fulll-
RNTI and RRCResumeRequest1 if the field is present, or shortl-RNTI and RRCResumeRequest
if the field is absent.

Another alternative can be to use the frequencyInfoDL IE provided in DownlinkConfigCommonSIB IE which is included in the ServingCellConfigCommonSIB IE.

### ServingCellConfigCommonSIB

The IE ServingCellConfigCommonSIB is used to configure cell specific parameters of a UE's serving cell in SIB1.

### ServingCellConfigCommonSIB Information Element

-- ASN1START
-- TAG-SERVINGCELLCONFIGCOMMONSIB-START

| | |
|---|---|
| ServingCellConfigCommonSIB ::= | SEQUENCE { |
| downlinkConfigCommon | DownlinkConfigCommonSIB, |
| uplinkConfigCommon | UplinkConfigCommonSIB |

OPTIONAL, -- Need R

| | |
|---|---|
| supplementaryUplink | UplinkConfigCommonSIB |

OPTIONAL, -- Need R

| | |
|---|---|
| n-TimingAdvanceOffset | ENUMERATED { n0, n25600, n39936 } |

OPTIONAL, -- Need S

| | |
|---|---|
| ssb-PositionsInBurst | SEQUENCE { |
| inOneGroup | BIT STRING (SIZE (8)), |
| groupPresence | BIT STRING (SIZE (8)) |

OPTIONAL -- Cond FR2-Only
},

| | |
|---|---|
| ssb-PeriodicityServingCell | ENUMERATED {ms5, ms10, ms20, ms40, ms80, |

ms160},

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |

```
  ...,
  [[
```

| | |
|---|---|
| channelAccessMode-r16 | CHOICE { |
| dynamic | NULL, |
| semiStatic | SemiStaticChannelAccessConfig |

}
OPTIONAL, -- Cond SharedSpectrum

| | |
|---|---|
| discoveryBurstWindowLength-r16 | ENUMERATED {ms0dot5, ms1, ms2, ms3, ms4, |

ms 5} OPTIONAL, -- Need R

| | |
|---|---|
| highSpeedConfig-r16 | HighSpeedConfig-r16 |

OPTIONAL -- Need R
]]
}
-- TAG-SERVINGCELLCONFIGCOMMONSIB-STOP
-- ASN1STOP

### DownlinkConfigCommonSIB

The IE DownlinkConfigCommonSIB provides common downlink parameters of a cell.

### DownlinkConfigCommonSIB Information Element

-- ASN1START
-- TAG-DOWNLINKCONFIGCOMMONSIB-START

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

...
}

| | |
|---|---|
| BCCH-Config ::= | SEQUENCE { |
| modificationPeriodCoeff | ENUMERATED {n2, n4, n8, n16}, |

...
}

| | |
|---|---|
| PCCH-Config ::= | SEQUENCE { |
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |
| firstPDCCH-MonitoringOccasionOfPO | CHOICE { |

```
      sCS15KHZoneT
SEQUENCE (SIZE (1..maxPO-perPF OF INTEGER (0..139),
      sCS30KHZoneT-SCS15KHZhalfT
SEQUENCE (SIZE (1..maxPO-perPF)) OF INTEGER (0..279),
      sCS60KHZoneT-SCS30KHZhalfT-SCS15KHZquarterT
SEQUENCE (SIZE (1..maxPO-perPF)) OF INTEGER (0..559),
      sCS120KHZoneT-SCS60KHZhalfT-SCS30KHZquarterT-SCS15KHZoneEighthT
SEQUENCE (SIZE (1..maxPO-perPF)) OF INTEGER (0..1119),
      sCS120KHZhalfT-SCS60KHZquarterT-SCS30KHZoneEighthT-SCS15KHZoneSixteenthT
SEQUENCE (SIZE (1..maxPO-perPF)) OF INTEGER (0..2239),
      sCS120KHZquarterT-SCS60KHZoneEighthT-SCS30KHZoneSixteenthT
SEQUENCE (SIZE (1..maxPO-perPF)) OF INTEGER (0..4479),
      sCS120KHZoneEighthT-SCS60KHZoneSixteenthT
SEQUENCE (SIZE (1..maxPO-perPF)) OF INTEGER (0..8959),
      sCS120KHZoneSixteenthT
SEQUENCE (SIZE (1..maxPO-perPF)) OF INTEGER (0..17919)
    } OPTIONAL, -- Need R
    ...,
    [[
    nrofPDCCH-MonitoringOccasionPerSSB-InPO-r16
```

| | |
|---|---|
| INTEGER (2..4) | OPTIONAL -- Cond SharedSpectrum2 |

```
    ]],
  [[
```

| | |
|---|---|
| frequencyInfoDL-NCD-r17 | FrequencyInfoDL-SIB-NCD, |

]]
}
-- TAG-DOWNLINKCONFIGCOMMONSIB-STOP
-- ASN1STOP

### FrequencyInfoDL-SIB-NCD

The IE FrequencyInfoDL-SIB-NCD provides basic parameters of a downlink carrier and transmission thereon.

FrequencyInfoDL-SIB-NCD information element

-- ASN1START
-- TAG-FREQUENCYINFODL-SIB-START

| | |
|---|---|
| FrequencyInfoDL-SIB-NCD ::= | SEQUENCE { |
| frequencyBandList-NCD | MultiFrequencyBandListNR-SIB-NCD, |
| offsetToPointA | INTEGER (0..2199), |
| scs-SpecificCarrierList | SEQUENCE (SIZE (1..maxSCSs)) OF SCS- |

SpecificCarrier
}
-- TAG-FREQUENCYINFODL-SIB-STOP
-- ASN1STOP

FrequencyInfoDL-SIB-NCD field descriptions

offsetToPointA
Represents the offset to Point A as defined in TS 38.211 [16], clause 4.4.4.2.
frequencyBandList-NCD
List of one or multiple frequency bands to which this carrier(s) belongs.
scs-SpecificCarrierList
A set of carriers for different subcarrier spacings (numerologies). Defined in relation to Point
A (see TS 38.211 [16], clause 5.3). The network configures this for all SCSs that are used in
DL BWPs in this serving cell.

### MultiFrequencyBandListNR-SIB-NCD

The IE MultiFrequencyBandListNR-SIB-NCD indicates the list of frequency bands, for which cell (re-)selection parameters are common, and a list of additionalPmax and additionalSpectrumEmission.

MultiFrequencyBandListNR-SIB-NCD information element

-- ASN1START
-- TAG-MULTI FREQUENCYBANDLISTNR-SIB-NCD-START

| | |
|---|---|
| MultiFrequencyBandListNR-SIB-NCD ::= | SEQUENCE (SIZE (1.. |

maxNrofMultiBands)) OF NR-MultiBandInfo-NCD

| | |
|---|---|
| NR-MultiBandInfo-NCD ::= | SEQUENCE { |
| freqBandIndicatorNR-NCD | FreqBandIndicatorNR-NCD |

OPTIONAL, -- Cond OptULNotSIB2

| | |
|---|---|
| nr-NS-PmaxList | NR-NS-PmaxList |

OPTIONAL -- Need S
}
-- TAG-MULTIFREQUENCYBANDLISTNR-SIB-NCD-STOP
-- ASN1STOP

NR-MultiBandInfo-NCD field descriptions

freqBandIndicatorNR-NCD
Provides an NR frequency band number as defined in TS 38.101-1 [15] and TS 38.101-2 [39],
table 5.2-1.
nr-NS-PmaxList
Provides a list of additionalPmax and additionalSpectrumEmission values. If the field is absent
the UE uses value 0 for the additionalSpectrumEmission (see TS 38.101-1 [15] table 6.2.3.1-
1A , and TS 38.101-2 [39], table 6.2.3.1-2).

| Conditional | |
|---|---|
| Presence | Explanation |
| OptULNotSIB2 | The field is absent for SIB2 and is mandatory present in SIB4 and |
| | frequencyInfoDL-SIB. Otherwise, if the field is absent in |
| | frequencyInfoUL-SIB in UplinkConfigCommonSIB, the UE will |
| | use the frequency band indicated in frequencyInfoDL-SIB in |
| | DownlinkConfigCommon SIB. |

### FreqBandIndicatorNR-NCD

The IE FreqBandIndicatorNR-NCD is used to convey an NR frequency band number as defined in TS 38.101-1 [15] and TS 38.101-2 [39]. It indicates the frequency band in which the NCD-SSB are located and according to which the UE shall perform the RRM measurements.

FreqBandIndicatorNR-NCD information element

| -- ASN1START | |
|---|---|
| -- TAG-FREQBANDINDICATORNR-NCD-START | |
| FreqBandIndicatorNR ::= | INTEGER (1..1024) |

-- TAG-FREQBANDINDICATORNR-NCD-STOP
-- ASN1STOP

Another alternative is to provide the FreqBandIndicatorNR-NCD IE in an extension of DownlinkConfigCommonSIB IE or in extension of ServingCellConfigCommonSIB IE.

Yet, another alternative is to provide the FrequencyInfoDL IE in the DownlinkConfigCommonSIB IE in an extension and extend the FrequencyInfoDL IE to introduce a parameter, e.g., absoluteFrequencyNCD-SSB that provides the ARFCN-ValueNR for NCD-SSB.

### FrequencyInfoDL

The IE FrequencyInfoDL provides basic parameters of a downlink carrier and transmission thereon.

### FrequencyInfoDL Information Element

-- ASN1START
-- TAG-FREQUENCYINFODL-START

| | |
|---|---|
| FrequencyInfoDL ::= | SEQUENCE { |
| absoluteFrequencySSB | ARFCN-ValueNR |

OPTIONAL, -- Cond SpCellAdd

| | |
|---|---|
| frequencyBandList | MultiFrequencyBandListNR, |
| absoluteFrequencyPointA | ARFCN-ValueNR, |
| scs-SpecificCarrierList | SEQUENCE (SIZE (1..maxSCSs)) OF SCS- |

```
SpecificCarrier,
    ...,
  [[
```

| | |
|---|---|
| absoluteFrequencyNCD-SSB-r17 | ARFCN-ValueNR |

]]
}
-- TAG-FREQUENCYINFODL-STOP
-- ASN1STOP

FrequencyInfoDL field descriptions

absoluteFrequencyPointA
Absolute frequency position of the reference resource block (Common RB 0). Its lowest
subcarrier is also known as Point A (see TS 38.211 [16], clause 4.4.4.2). Note that the
lower edge of the actual carrier is not defined by this field but rather in the scs-
SpecificCarrierList.
absoluteFrequencySSB
Frequency of the SSB to be used for this serving cell. SSB related parameters (e.g. SSB
index) provided for a serving cell refer to this SSB frequency unless mentioned otherwise.
The cell-defining SSB of the PCell is always on the sync raster. Frequencies are
considered to be on the sync raster if they are also identifiable with a GSCN value (see
TS 38.101-1 [15]). If the field is absent, the SSB related parameters should be absent,
e.g. ssb-PositionsinBurst, ssb-periodicityServingCell and subcarrierSpacing in
ServingCellConfigCommon IE. If the field is absent, the UE obtains timing reference from
the SpCell. This is only supported in case the SCell is in the same frequency band as the
SpCell.
absoluteFrequencyNCD-SSB
Frequency of the NCD SSB to be used for this serving cell. NCD-SSB related parameters
(e.g. NCD-SSB index) provided for a serving cell refer to this NCD-SSB frequency unless
mentioned otherwise.
frequencyBandList
List containing only one frequency band to which this carrier(s) belongs. Multiple values
are not supported.
scs-SpecificCarrierList
A set of carriers for different subcarrier spacings (numerologies). Defined in relation to
Point A. The network configures a scs-SpecificCarrier at least for each numerology (SCS)
that is used e.g. in a BWP (see TS 38.211 [16], clause 5.3).

| Conditional Presence | Explanation |
|---|---|
| SpCellAdd | The field is mandatory present if this FrequencyInfoDL is |
| | for SpCell. Otherwise the field is optionally present, Need |
| | S. |

Obtaining RS2 Configuration (e.g. NCD-SSB Configuration) without Acquiring the SI of Cell2:

In these examples it is assumed that the UE acquires the RS2 configuration (e.g. NCD-SSB configuration) without acquiring the SI of cell2. The UE may be acquiring the SI for other reasons e.g. for CGI reading. These may be relevant for scenarios where the RS2 configuration is not transmitted in the SI of cell2 or when the UE is not expected to acquire the SI of cell2.

In one specific example, cell2 is a newly detected cell. The UE (e.g. BR UE) shall be able to identify a new detectable cell. The UE may further transmit measurement results (e.g. RSRP, RSRQ) of cell2 to cell1. After that, cell1 can indicate or configure or request the UE (e.g. BR UE) to report whether RS2 (e.g. NCD-SSB) is transmitted in cell 2. The total delay T_{identify} can be as follows.

If cell1 doesn't indicate NCD-SSB identification,

T_{identify}=T_{PSS/SSS_sync_CD_SSB}+T_{CD_SSB_measurement_period}+T_{CD_SSB_time_index}

If cell1 indicates NCD-SSB identification,

T_{identify}=T_{PSS/SSS_sync_CD_SSB}+T_{CD_SSB_measurement_period}+T_{CD_SSB_time_index}+T_{NCD_SSB_detect}
Where,
T_{PSS/SSS_sync_CD_SSB} is the time period used in PSS/SSS detection by CD-SSB.
T_{CD_SSB_measurement_period} is a measurement period of CD-SSB based measurement.
T_{CD_SSB_time_index} is the time period used to acquire the index of the CD-SSB being measured if indicated by NW. If the UE is not requested to acquire the index of RS1 (e.g. CD-SSB) then T_{CD_SSB_time_index}=0.
T_{NCD_SSB_detect} is the time period used in NCD-SSB detection.

Examples of methods to detect the RS2 (e.g. NCD-SSB) transmission configuration to be applied in the cell2 by the UE (e.g. BR UE) (e.g. in different scenarios) are described below:
In one example UE will blindly detect the RS2 (e.g. NCD-SSB) transmission in the carrier edge of the cell2. For example: UE will sweep the total frequency bandwidth f0(MHz) in each carrier frequency edge of the cell 2 by a received frequency bandwidth f2(MHz) with a frequency step f1(MHz).
In one specific example, the total frequency bandwidth can be equal to the bandwidth of the UE (e.g. BR UE such as 20 MHz). An example of the search is shown in FIG. 13, which shows an example of UE searching NCD-SSB with a step equaling f1 Hz.
In one specific example, cell2 is a newly detected cell. The UE (e.g. BR UE) shall be able to identify a new detectable cell within T_{identify} based on RS1 (e.g. CD-SSB). The UE may further transmits the measurement results of one or more measurements (e.g. RSRP, RSRQ etc) done on RS1 (e.g. CD-SSB) to NN1.

After that, NN1 serving cell1 can indicate or request or configure the UE (e.g. BR UE) to additionally report the measurement based on RS2 (e.g. NCD-SSB). The total delay T_{identify} can be as follow.

Cell1 may indicate or request the UE to perform RS2 (e.g. NCD-SSB) identification. An example of time required to identify RS2 (e.g. NCD-SSB) and report measurement results for RS2 can be expressed as follows:

T_{identify}=T_{PSS/SSS_sync_CD_SSB}+T_{CD_SSB_measurement_period}+T_{CD_SSB_time_index}+T_{NCD_SSB_detect}+T_{NCD_SSB_measurement_period}

Alternatively, cell1 can indicate or request the UE (e.g. BR UE) to only report the measurement based on RS2 (e.g. NCD-SSB) e.g. if the RS2 is already identified by the UE or the UE knows the time-frequency location of RS2. In this case an example of the total delay T_{identify} can be as follows.

T_{identify}=T_{PSS/SSS_sync_CD_SSB}+T_{NCD_SSB_measurement_period}+T_{CD_SSB_time_index}
Where, T_{NCD_SSB_measurement_period} is a measurement period of NCD-SSB based measurement.

In the above examples if the UE is not requested to acquire the index of RS1 (e.g. CD-SSB) then T_{CD_SSB_time_index}=0.

The method to determine the NCD-SSB transmission configuration to be applied in the cell2 is the same as described above.

In one general example, the UE (e.g. BR UE) is configured to measure the signal strength and/or signal quality (RSRP/RSRQ/RSSI/SINR etc.) of cell2 on RS2 and is provided with RS2 frequency information (e.g. ssb frequency location such as frequency location of NCD-SSB).
In one specific example, cell2 is a newly detected cell. The UE (e.g. BR UE) shall be able to identify a new detectable cell. After that, it shall be able to measure the cell within Tₘₑₐₛ based on NCD-SSB. The total delay T_{identify} can be as follows.

T_{identify}=T_{PSS/SSS_sync_CD_SSB}+T_{NCD_SSB_measurement_period}+T_{CD_SSB_time_index}

Tₘₑₐₛ=T_{NCD_SSB_measurement_period}
In one specific example, cell2 is a detected cell. The UE (e.g. BR UE) shall be able to measure the cell within Tₘₑₐₛ based on RS2 (e.g. NCD-SSB).

Tₘₑₐₛ=T_{NCD_SSB_measurement_period}

In the above example if the UE is not requested to acquire the index of RS1 (e.g. CD-SSB) then T_{CD_SSB_time_index}=0.

In another example, cell1 configures the UE to perform measurements on cell2 on RS1 and/or RS2 e.g. the UE may be configured with the ssb frequency location of CD-SSB and NCD-SSB. In one example the UE (e.g. BR UE) may decide to perform measurements on RS1 (e.g. CD-SSB) or on RS2 (e.g. NCD-SSB). When UE reports the measurement reporting, UE additionally reports information about the related RS on which the measurement is done e.g. on RS1 or on RS2 e.g. ssb type, such as CD-SSB or NCD-SSB. RS information can be tagged or associated with the reported measurement which enable the network node (e.g. NN1) identifies on which RS the measurement has been done.
In one specific example, cell1 configure the UE to perform measurements on RS1 and RS2 e.g. with ssb frequency as ARFCN and with both CD-SSB and NCD-SSB measurements. The UE will first perform measurements on CD-SSB and report the measurements with CD-SSB frequency. Additionally, UE will also report the measurements on NCD-SSB. The total delay Tₘₑₐₛ can be as follows.

Tₘₑₐₛ=T_{CD_SSB_measurement_period}+T_{NCD_SSB_measurement_period}
In one specific example, cell1 is configured the measurement with ssb frequency as ARFCN. It's up to RB UE to decide which type of SSB will be used.

For example, UE will perform measurements on NCD-SSB and report the measurements type as NCD-SSB. The total delay T_{identify} and measurement delay Tₘₑₐₛ can be as follows.

T_{identify}=T_{PSS/SSS_sync_CD_SSB}+T_{NCD_SSB_measurement_period}+T_{CD_SSB_time_index}

Tₘₑₐₛ=T_{NCD_SSB_measurement_period}

For example, UE will perform measurements on CD-SSB and report the measurements type as CD-SSB. The total delay T_{identify} and measurement delay Tₘₑₐₛ can be as follows.

T_{identify}=T_{PSS/SSS_sync_CD_SSB}+T_{CD_SSB_measurement_period}+T_{CD_SSB_time_index}

Tₘₑₐₛ=T_{CD_SSB_measurement_period}

In the above example if the UE is not requested to acquire the index of RS1 (e.g. CD-SSB) then T_{CD_SSB_time_index}=0.

In another general example, there is a capability (such as supportNCDSSBdetect) to report whether non-BR UE supports NCD-SSB transmission detection. When non-BR UE is configured to measure the signal strength(RSRP/RSRQ/RSSI etc.) of cell2 with ssb frequency as CD-SSB, non-BR UE can further report the capability(supportNCDSSBdetect) as true.
In one specific example, if UE reports that it supports NCD-SSB transmission detection, UE may additionally detect whether NCD-SSB is transmitted in cell2 based on cell1's indication. If cell1 indicates NCD-SSB identification, the total delay T_{identify} can be as follows.

T_{identify}=T_{PSS/SSS_sync_CD_SSB}+T_{CD_SSB_measurement_period}+T_{CD_SSB_time_index}+T_{NCD_SSB_detect}

In the above example if the UE is not requested to acquire the index of RS1 (e.g. CD-SSB) then T_{CD_SSB_time_index}=0.

### Embodiment #3: Method in a NW of Obtaining RS2 (e.g. NCD-SSB) Information by the NW(NN2)

In one example, the UE obtains the RS2 configuration in cell2 by acquiring or receiving or reading the system information (SI) (e.g. MIB, SIB1 etc) of cell2 from a second network node (NN2) forward to a first network node (NN1, also referred to in some examples above as simply network node).

This mechanism may be applied if the information about the RS2 configuration (e.g. ARFCN, NCD-SSB index etc) is transmitted by cell2. The NN2 will indicate NN1 through Xn interface through SN information exchange.

NN2 may transmit RS2 information associated with cell2 to NN1 using one or more of the following mechanisms:
In one example, NN2 may transmit RS2 information to NN1 autonomously or proactively e.g. periodically.
In another example, NN2 may transmit RS2 information to NN1 when one or more criteria are met e.g. when UE is triggered to perform cell change to cell2.
In another example, NN2 may transmit RS2 information to NN1 upon receiving a request from another network node e.g. from NN1. For example, if the NN1 requests NN2 to provide RS2 information for cell2.
In another example, NN2 may transmit RS2 information to NN1 via signaling over an interface between NN2 and NN1 e.g. over Xn interface. This could for example be used upon handover to another cell, in which case gNB would in the handover request over Xn check if the target cells support the RS2 transmission before handing over the UE to the target cell. In the case of RedCap this would correspond to adding e.g. the parameter ncdSSBindication to the handover request signaling over Xn. In another example, NN2 may transmit RS2 information to NN1 via signaling via an intermediate node e.g. via core network.

NN1 may use the received RS2 information for one or more tasks. Examples of tasks are:
Indicating the measurements for RS2 to UE
Indicating the handover from NN1 to NN2

### Embodiment #4: Method in a UE of Reporting NCD-SSB Information by CGI Reporting Procedure

This embodiment scenario comprises of a UE (which can be e.g. non-BR UE or a BR UE) served by a first cell (cell1) which is managed by a first network node (NN1), and there is a second cell (cell2). The UE is requested by cell1 to read the global cell ID for the second cell (cell2).

In one general example, BR UE is asked/requested by NN1 to report the global cell ID and together with RS2 transmission information such as RS2 configuration (e.g. NCD-SSB transmission status) for cell2. The BR UE may acquire the RS2 configuration by reading SI of cell2 or without reading SI of cell2 (e.g. by blind detection) as described in previous examples.

In another example, when non-BR UE reports the capability (supportNCDSSBdetect) as true, NN1 may request non-BR UE to report the global cell ID and together with RS2 configuration in cell2 (e.g. NCD-SSB transmission status for cell2). The non-BR UE may acquire the RS2 configuration by reading SI of cell2 or without reading SI of cell2 (e.g. by blind detection) as described in previous examples.

Examples of scenarios for cell1 to indicate the reporting for RS2 configuration on cell2 (e.g. NCD-SSB transmission) are described below:
1. In one example, cell1 is configured to use ANR function to relieve the operator from the burden of manually managing NCRs. To further evaluate the neighbour cells interference of NCD-SSB, cell1 requests UE to report the NCD-SSB transmission status with the global cell IDs.
2. In another example, cell1 is determined to configure handover command to a BR UE to handover to cell2. When the UE reports the NCD-SSB transmission in cell2, cell1 can directly indicate the handover to a specific BWP for BR UE.
3. In another example, UE is configured to provide measurement reports in cell 1 based on CD-SSB or NCD-SSB transmission in cell2. The configuration provided by cell 1 may include a scaling factor for a measurement based on NCD-SSB per neighbor cell so that the UE can apply those before transmitting the measurement reports based on NCD-SSB to cell 1. Alternatively, the gNB may apply the scaling factor to a reported measurement assuming that the UE indicates whether it is based on NCD-SSB. In yet another example, cell 1 configures the UE with conditional handover by providing thresholds with respect to the measurements in cell1 and the target candidate cells. If such measurements are based on NCD-SSB, e.g., in the source or the target candidate cell, the source cell may provide scaling factors for the UE to apply to the measurements to decide on when it is a proper time to trigger the handover procedure.

According to a method specified above, UE obtains information about the NCD-SSB configured by cell2. UE reports NCD-SSB status together with global cell ID to NN1 based on CGI reading reporting.

FIG. 13 shows an example of a communication system QQ100 in accordance with some embodiments. In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 13, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection.

In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 14 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-loT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIGS. 3 and/or 5.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium. The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input. A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-loT standard. In other scenarios, a UE may represent a vehicle, such as a car, a bus, a truck, a ship and an airplane, or other equipment that is capable of monitoring and/or reporting on its operational status or other functions associated with its operation. In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio.

Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIGS. 2 and/or 4.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 15 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

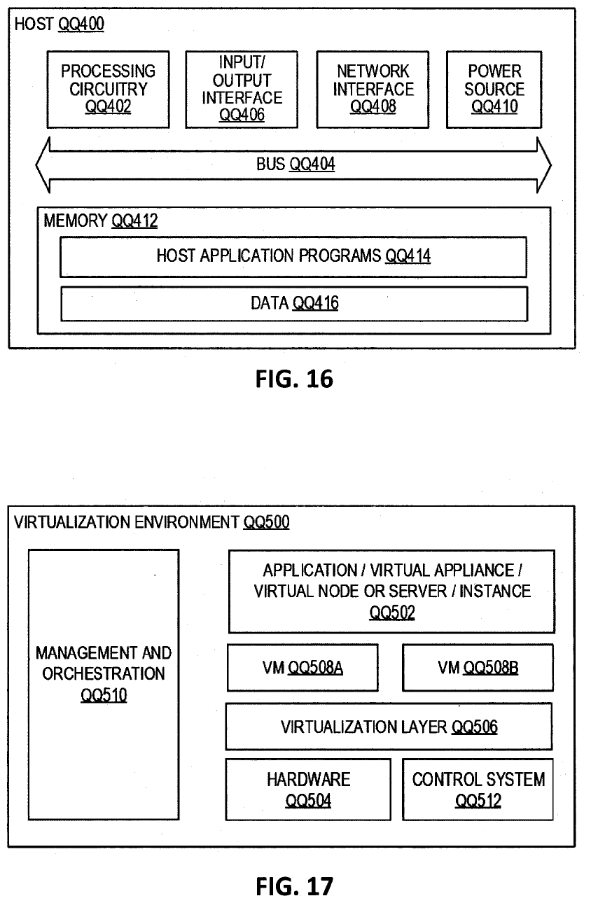

FIG. 16 is a block diagram of a host QQ400, which may be an embodiment of the host QQ116 of FIG. 13, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 14 and 15, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

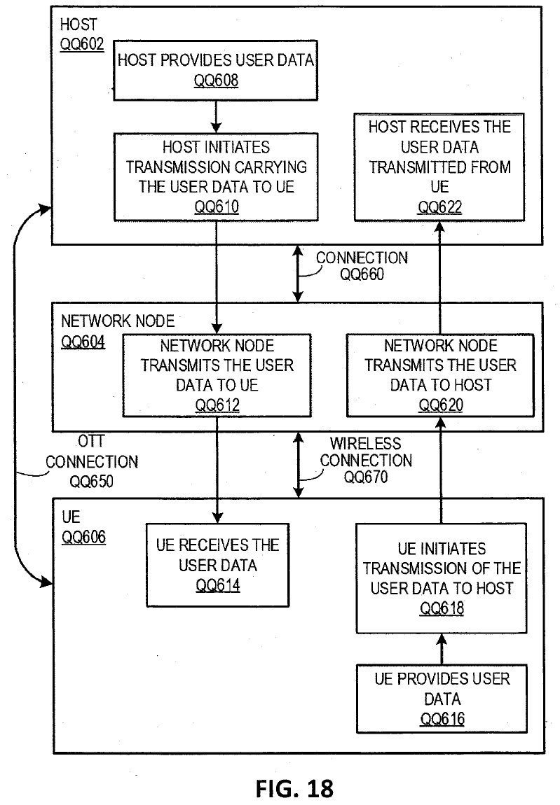

FIG. 18 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 13 and/or UE QQ200 of FIG. 14), network node (such as network node QQ110a of FIG. 13 and/or network node QQ300 of FIG. 15), and host (such as host QQ116 of FIG. 13 and/or host QQ400 of FIG. 16) discussed in the preceding paragraphs will now be described with reference to FIG. 18.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 13) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650. The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve system performance and thereby provide benefits such as improved network efficiency etc.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc. Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiments of this disclosure include the following enumerated embodiments:

1. A method in a network node of determining a configuration of a User Equipment (UE) to perform a measurement on a second cell, wherein the UE is served by a first cell, the method comprising:
determining whether the measurement is an inter-frequency measurement or an intra-frequency measurement based on a frequency of a first reference signal on the first cell and a frequency of a first reference signal on the second cell; and
determining whether the measurement is to be performed with or without a measurement gap based on the frequency of the first reference signal on the second cell and based on:
   (i) the frequency of the first reference signal on the first cell or a frequency of a second reference signal on the first cell; and/or
   (ii) an active bandwidth part (BWP) of the UE on the first cell.

2. The method of embodiment 1, comprising determining that the measurement is an inter-frequency measurement if the frequency of the first reference signal on the first cell is different to the frequency of the first reference signal on the second cell.

3. The method of any of the preceding embodiments, comprising determining that the measurement is an intra-frequency measurement if the frequency of the first reference signal on the first cell is the same as the frequency of the first reference signal on the second cell.

4. The method of any of the preceding embodiments, comprising determining that the measurement is to be performed with no measurement gap if:
the measurement is determined to be an inter-frequency measurement; and
the frequency of the first reference signal on the second cell is within the active BWP of the UE on the first cell.

5. The method of any of the preceding embodiments, comprising determining that the measurement is to be performed with a measurement gap if:
the measurement is determined to be an inter-frequency measurement; and
the frequency of the first reference signal on the second cell is not within the active BWP of the UE on the first cell.

6. The method of any of the preceding embodiments, comprising determining that the measurement is to be performed with a measurement gap if:
the measurement is determined to be an inter-frequency measurement; and
the frequency of the first reference signal on the second cell is the same as the frequency of the second reference signal on the first cell.

7. The method of any of the preceding embodiments, comprising determining that the measurement is to be performed with no measurement gap if:
the measurement is determined to be an inter-frequency measurement; and
the frequency of the first reference signal on the second cell is different to the frequency of the second reference signal on the first cell.

8. The method of any of the preceding embodiments, comprising determining that the measurement is to be performed with no measurement gap if:
the measurement is determined to be an intra-frequency measurement; and
the frequency of the first reference signal on the second cell is within the active BWP of the UE on the first cell.

9. The method of any of the preceding embodiments, comprising determining that the measurement is to be performed with a measurement gap if:
the measurement is determined to be an intra-frequency measurement; and
the frequency of the first reference signal on the second cell is not within the active BWP of the UE on the first cell.

10. The method of any of the preceding embodiments, wherein the UE comprises a reduced bandwidth UE (RB UE) or a reduced capability UE (Redcap UE).

11. The method of any of the preceding embodiments, wherein the first reference signal on the first cell comprises a cell-defining synchronization signal and PBCH block (CD-SSB) or a non-cell-defining synchronization signal and PBCH block (NCD-SSB).

12. The method of any of the preceding embodiments, wherein the second reference signal on the first cell comprises a cell-defining synchronization signal and PBCH block (CD-SSB) or a non-cell-defining synchronization signal and PBCH block (NCD-SSB).

13. The method of any of the preceding embodiments, wherein the first reference signal on the second cell comprises a cell-defining synchronization signal and PBCH block (CD-SSB) or a non-cell-defining synchronization signal and PBCH block (NCD-SSB).

14. The method of any of the preceding embodiments, wherein the network node manages the first cell and/or the second cell.

15. The method of any of the preceding embodiments, wherein the measurement comprises a measurement of the first reference signal on the second cell, or a measurement of a CSI-RS, CRS, DMRS, PSS, SSS, discovery reference signal (DRS) or PRS on the second cell.

16. The method of any of the preceding embodiments, comprising sending the configuration of the measurement to the UE, wherein the configuration identifies the frequency of the first reference signal on the second cell.

17. The method of any of the preceding embodiments, comprising receiving an indication of a result of the measurement from the UE.

18. A method in a User Equipment (UE) of determining a configuration of a measurement on a second cell, wherein the UE is served by a first cell, the method comprising:
determining whether the measurement is an inter-frequency measurement or an intra-frequency measurement based on a frequency of a first reference signal on the first cell and a frequency of a first reference signal on the second cell; and
determining whether the measurement is to be performed with or without a measurement gap based on the frequency of the first reference signal on the second cell and based on:
   (i) the frequency of the first reference signal on the first cell or a frequency of a second reference signal on the first cell; and/or
   (ii) an active bandwidth part (BWP) of the UE on the first cell.

19. The method of embodiment 18, comprising determining that the measurement is an inter-frequency measurement if the frequency of the first reference signal on the first cell is different to the frequency of the first reference signal on the second cell.

20. The method of embodiment 18 or 19, comprising determining that the measurement is an intra-frequency measurement if the frequency of the first reference signal on the first cell is the same as the frequency of the first reference signal on the second cell.

21. The method of any of embodiments 18 to 20, comprising determining that the measurement is to be performed with no measurement gap if:
the measurement is determined to be an inter-frequency measurement; and
the frequency of the first reference signal on the second cell is within the active BWP of the UE on the first cell.

22. The method of any of embodiments 18 to 21, comprising determining that the measurement is to be performed with a measurement gap if:
the measurement is determined to be an inter-frequency measurement; and
the frequency of the first reference signal on the second cell is not within the active BWP of the UE on the first cell.

23. The method of any of embodiments 18 to 22, comprising determining that the measurement is to be performed with a measurement gap if:
the measurement is determined to be an inter-frequency measurement; and
the frequency of the first reference signal on the second cell is the same as the frequency of the second reference signal on the first cell.

24. The method of any of embodiments 18 to 23, comprising determining that the measurement is to be performed with no measurement gap if:
the measurement is determined to be an inter-frequency measurement; and
the frequency of the first reference signal on the second cell is different to the frequency of the second reference signal on the first cell.

25. The method of any of embodiments 18 to 24, comprising determining that the measurement is to be performed with no measurement gap if:
the measurement is determined to be an intra-frequency measurement; and
the frequency of the first reference signal on the second cell is within the active BWP of the UE on the first cell.

26. The method of any of embodiments 18 to 25, comprising determining that the measurement is to be performed with a measurement gap if:
the measurement is determined to be an intra-frequency measurement; and
the frequency of the first reference signal on the second cell is not within the active BWP of the UE on the first cell.

27. The method of any of embodiments 18 to 26, wherein the UE comprises a reduced bandwidth UE (RB UE) or a reduced capability UE (Redcap UE).

28. The method of any of embodiments 18 to 27, wherein the first reference signal on the first cell comprises a cell-defining synchronization signal and PBCH block (CD-SSB) or a non-cell-defining synchronization signal and PBCH block (NCD-SSB).

29. The method of any of embodiments 18 to 28, wherein the second reference signal on the first cell comprises a cell-defining synchronization signal and PBCH block (CD-SSB) or a non-cell-defining synchronization signal and PBCH block (NCD-SSB).

30. The method of any of embodiments 18 to 29, wherein the first reference signal on the second cell comprises a cell-defining synchronization signal and PBCH block (CD-SSB) or a non-cell-defining synchronization signal and PBCH block (NCD-SSB).

31. The method of any of embodiments 18 to 30, wherein the measurement comprises a measurement of the first reference signal on the second cell, or a measurement of a CSI-RS, CRS, DMRS, PSS, SSS, discovery reference signal (DRS) or PRS on the second cell.

32. The method of any of embodiments 18 to 31, comprising performing the measurement according to the determination of whether the measurement is an inter-frequency measurement or an intra-frequency measurement, and according to the determination of whether the measurement is to be performed with or without a measurement gap, to obtain a measurement result.

33. The method of any of embodiments 18 to 32, comprising receiving a configuration of the measurement from a network node, wherein the configuration identifies the frequency of the first reference signal on the second cell.

34. The method of embodiment 33, comprising logging the measurement result and/or sending an indication of the measurement result to a network node.

35. The method of embodiment 33 or 34, wherein the network node manages the first cell and/or the second cell.

36. The method of any of the preceding embodiments, wherein the measurement comprises a measurement of signal strength, RSRP and/or path loss of the first reference signal on the second cell, and/or a measurement of signal quality, RSRQ, RSSI, SNR and/or SINR of the first reference signal on the second cell.

37. The method of any of the preceding embodiments, wherein the network node comprises a NodeB, base station (BS), multi-standard radio (MSR) radio node, MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit, Distributed Unit, Baseband Unit, Centralized Baseband, C-RAN, access point (AP), transmission point, transmission node, transmission reception point (TRP), RRU, RRH, node in distributed antenna system (DAS), core network node, O&M node, OSS, SON, or positioning node.

38. A method in a network node of receiving a report from a User Equipment (UE), wherein the UE is served by a first cell and the report is associated with a second cell, the method comprising:
receiving a report from the UE, wherein the report indicates whether a second reference signal is being transmitted in the second cell or the report indicates whether the report is associated with the second reference signal or with a first reference signal.

39. The method of embodiment 38, wherein indicating that the report is associated with the second reference signal comprises indicating that the report is associated with a measurement which is performed by the UE on the second reference signal in the second cell.

40. The method of embodiment 38, wherein indicating that the report is associated with the first reference signal comprises indicating that the report is associated with a measurement which is performed by the UE on the first reference signal in the second cell.

41. The method of any of embodiments 38 to 40, further comprising sending a configuration to the UE, wherein the configuration instructs the UE to report a measurement on at least one of the first reference signal on the second cell and the second reference signal on the second cell.

42. The method of any of embodiments 38 to 41, wherein the second reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

43. The method of any of embodiments 38 to 42, wherein the report comprises a measurement report.

44. The method of embodiment 43, wherein the measurement report includes an indication of a measurement of a first reference signal on the second cell.

45. The method of embodiment 44, comprising sending a configuration to the UE, wherein the configuration instructs the UE to report a measurement of the first reference signal on the second cell, and instructs the UE to report whether the NCD-SSB is being broadcast on the second cell.

46. The method of embodiment 45, wherein the configuration identifies a frequency location of the first reference signal.

47. The method of any of embodiments 44 to 46, wherein the first reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

48. The method of any of embodiments 44 to 47, wherein the measurement of the first reference signal on the second cell comprises a measurement of signal strength, RSRP and/or path loss of the first reference signal on the second cell, and/or a measurement of signal quality, RSRQ, RSSI and/or SINR of the first reference signal on the second cell.

49. The method of any of embodiments 44 to 48, wherein the measurement report includes an indication of a measurement of a second reference signal on the second cell.

50. The method of embodiment 49, comprising sending a configuration to the UE, wherein the configuration instructs the UE to report a measurement of the second reference signal on the second cell.

51. The method of embodiment 50, wherein the configuration identifies a frequency location of the second reference signal.

52. The method of any of embodiments 49 to 51, wherein the second reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

53. The method of any of embodiments 49 to 52, wherein the measurement of the second reference signal on the second cell comprises a measurement of signal strength, RSRP and/or path loss of the second reference signal on the second cell, and/or a measurement of signal quality, RSRQ, RSSI and/or SINR of the second reference signal on the second cell

54. The method of any of embodiments 38 to 53, wherein the report indicates a cell global identifier (CGI) for the second cell.

55. The method of embodiment 54, comprising sending a configuration to the UE, wherein the configuration instructs the UE to report the CGI for the second cell and instructs the UE to report whether the NCD-SSB is being broadcast on the second cell.

56. The method of any of embodiments 38 to 55, wherein the report identifies at least one of:
a time-frequency resource for the NCD-SSB on the second cell;
a frequency location for the NCD-SSB on the second cell;
a frequency channel number for the NCD-SSB on the second cell;
an absolute radio frequency channel number (ARFCN) for the NCD-SSB on the second cell;
a frequency offset from a reference frequency for the NCD-SSB on the second cell; and/or
timing information for the NCD-SSB on the second cell.

57. The method of any of embodiments 38 to 56, comprising storing an indication of whether the NCD-SSB is being broadcast on the second cell.

58. The method of embodiment 57, comprising storing the indication in a Neighbour Cell Relation Table (NCRT).

59. The method of any of embodiments 38 to 58, wherein the network node manages the first cell and/or the second cell.

60. The method of any of embodiments 38 to 59, wherein the network node comprises a NodeB, base station (BS), multi-standard radio (MSR) radio node, MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit, Distributed Unit, Baseband Unit, Centralized Baseband, C-RAN, access point (AP), transmission point, transmission node, transmission reception point (TRP), RRU, RRH, node in distributed antenna system (DAS), core network node, O&M node, OSS, SON, or positioning node.

61. The method of any of embodiments 38 to 60, wherein the UE comprises a reduced bandwidth UE (RB UE), a reduced capability UE (Redcap UE), a non-RB UE or a non-Redcap UE.

62. The method of any of embodiments 38 to 61, comprising receiving information associated with the reference signal on the second cell from a second network node.

63. The method of embodiment 62, comprising sending the information to the UE.

64. The method of embodiment 62 or 63, wherein the information comprises one or more of:
a time-frequency resource for the NCD-SSB on the second cell;
a frequency location for the NCD-SSB on the second cell;
a frequency channel number for the NCD-SSB on the second cell;
an absolute radio frequency channel number (ARFCN) for the NCD-SSB on the second cell;
a frequency offset from a reference frequency for the NCD-SSB on the second cell; and/or
timing information for the NCD-SSB on the second cell.

65. The method of any of embodiments 62 to 64, comprising receiving the information from the second network node:
in response to a request from the network node; and/or
in response to a trigger of a cell change of the UE from the first cell to the second cell.

66. The method of any of embodiments 62 to 65, comprising receiving the information from the second network node:
over an Xn interface; and/or
via a core network.

67. A method in a User Equipment (UE) of sending a report to a network node, wherein the UE is served by a first cell and the report is associated with a second cell, the method comprising:
sending a report to the network node, wherein the report indicates whether a second reference signal is being transmitted in the second cell or the report indicates whether the report is associated with the second reference signal or with a first reference signal.

68. The method of embodiment 67, wherein indicating that the report is associated with the second reference signal comprises indicating that the report is associated with a measurement which is performed by the UE on the second reference signal in the second cell.

69. The method of embodiment 67, wherein indicating that the report is associated with the first reference signal comprises indicating that the report is associated with a measurement which is performed by the UE on the first reference signal in the second cell.

70. The method of embodiment 67, further comprising receiving a configuration from the network node, wherein the configuration instructs the UE to report a measurement on at least one of the first reference signal on the second cell and the second reference signal on the second cell.

71. The method of any of the embodiments 67-70, further comprising determining based on one or more criteria whether to perform the measurement on the first reference signal on the second cell or the second reference signal on the second cell.

72. The method of any of embodiments 38 to 41, wherein the second reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

73. The method of any of embodiments 67 to 72, comprising determining whether the NCD-SSB is being broadcast on the second cell from system information (SI) broadcast on the second cell.

74. The method of embodiment 73, wherein the SI comprises a master information block (MIB), system information block (SIB) or system information block 1 (SIB1).

75. The method of embodiment 73 or 74, comprising obtaining, from the SI, at least one of:
a time-frequency resource for the NCD-SSB on the second cell;
a frequency location for the NCD-SSB on the second cell;
a frequency channel number for the NCD-SSB on the second cell;
an absolute radio frequency channel number (ARFCN) for the NCD-SSB on the second cell;
a frequency offset from a reference frequency for the NCD-SSB on the second cell; and/or
timing information for the NCD-SSB on the second cell.

76. The method of any of embodiments 73 to 75, comprising determining whether the NCD-SSB is being broadcast on the second cell:
in response to an instruction from the network node to determine whether the NCD-SSB is being broadcast on the second cell;
in response to an instruction from the network node to obtain System Information (SI) for the second cell; and/or
in response to a trigger of a cell change of the UE from the first cell to the second cell.

77. The method of any of embodiments 67 to 76, comprising detecting the NCD-SSB by performing a frequency sweep of at least part of a bandwidth of the second cell.

78. The method of aby of embodiments 67 to 77, wherein the report comprises a measurement report.

79. The method of embodiment 78, wherein the measurement report includes an indication of a measurement of a first reference signal on the second cell.

80. The method of embodiment 79, comprising receiving a configuration from the network node, wherein the configuration instructs the UE to report a measurement of the first reference signal on the second cell, and instructs the UE to report whether the NCD-SSB is being broadcast on the second cell.

81. The method of embodiment 80, wherein the configuration identifies a frequency location of the first reference signal.

82. The method of any of embodiments 79 to 81, wherein the first reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

83. The method of any of embodiments 79 to 82, wherein the measurement of the first reference signal on the second cell comprises a measurement of signal strength, RSRP and/or path loss of the first reference signal on the second cell, and/or a measurement of signal quality, RSRQ, RSSI and/or SINR of the first reference signal on the second cell.

84. The method of any of embodiments 79 to 83, wherein the measurement report includes an indication of a measurement of a second reference signal on the second cell.

85. The method of embodiment 84, comprising receiving a configuration from the network node, wherein the configuration instructs the UE to report a measurement of the second reference signal on the second cell.

86. The method of embodiment 85, wherein the configuration identifies a frequency location of the second reference signal.

87. The method of any of embodiments 84 to 86, wherein the second reference signal on the second cell comprises a cell-defining synchronization signal and PBCH block (CD-SSB), non-cell-defining synchronization signal and PBCH block (NCD-SSB), CSI-RS, CRS, DMRS, PSS, SSS, discovery reference signal (DRS) or PRS.

88. The method of any of embodiments 84 to 87, wherein the measurement of the second reference signal on the second cell comprises a measurement of signal strength, RSRP and/or path loss of the second reference signal on the second cell, and/or a measurement of signal quality, RSRQ, RSSI and/or SINR of the second reference signal on the second cell

89. The method of any of embodiments 67 to 88, wherein the report indicates a cell global identifier (CGI) for the second cell.

90. The method of embodiment 89, comprising receiving a configuration from the network node, wherein the configuration instructs the UE to report the CGI for the second cell and instructs the UE to report whether the NCD-SSB is being broadcast on the second cell.

91. The method of any of embodiments 67 to 90, wherein the report identifies at least one of:
a time-frequency resource for the NCD-SSB on the second cell;
a frequency location for the NCD-SSB on the second cell;
a frequency channel number for the NCD-SSB on the second cell;
an absolute radio frequency channel number (ARFCN) for the NCD-SSB on the second cell;
a frequency offset from a reference frequency for the NCD-SSB on the second cell; and/or
timing information for the NCD-SSB on the second cell.

92. The method of any of embodiments 67 to 91, comprising storing an indication of whether the NCD-SSB is being broadcast on the second cell.

93. The method of any of embodiments 6673 to 92, wherein the network node manages the first cell and/or the second cell.

94. The method of any of embodiments 67 to 93, wherein the network node comprises a NodeB, base station (BS), multi-standard radio (MSR) radio node, MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit, Distributed Unit, Baseband Unit, Centralized Baseband, C-RAN, access point (AP), transmission point, transmission node, transmission reception point (TRP), RRU, RRH, node in distributed antenna system (DAS), core network node, O&M node, OSS, SON, or positioning node.

95. The method of any of embodiments 67 to 94, wherein the UE comprises a reduced bandwidth UE (RB UE), a reduced capability UE (Redcap UE), a non-RB UE or a non-Redcap UE.

96. A user equipment comprising:
processing circuitry configured to cause the user equipment to perform any of the steps of any of embodiments 18-37 and 67-95; and
power supply circuitry configured to supply power to the processing circuitry.

97. A network node comprising:
processing circuitry configured to cause the network node to perform any of the steps of any of embodiments 1-17 and 38-66;
power supply circuitry configured to supply power to the processing circuitry.

98. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of embodiments 18-37 and 67-95;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

99. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of embodiments 18-37 and 67-95 to receive the user data from the host.

100. The host of the previous embodiment, wherein the cellular network further includes a network node configured to communicate with the UE to transmit the user data to the UE from the host.

101. The host of the previous 2 embodiments, wherein:
the processing circuitry of the host is configured to execute a host application, thereby providing the user data; and
the host application is configured to interact with a client application executing on the UE, the client application being associated with the host application.

102. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of embodiments 18-37 and 67-95 to receive the user data from the host.

103. The method of the previous embodiment, further comprising:
at the host, executing a host application associated with a client application executing on the UE to receive the user data from the UE.

104. The method of the previous embodiment, further comprising:
at the host, transmitting input data to the client application executing on the UE, the input data being provided by executing the host application,
wherein the user data is provided by the client application in response to the input data from the host application.

105. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of embodiments 18-37 and 67-95 to transmit the user data to the host.

106. The host of the previous embodiment, wherein the cellular network further includes a network node configured to communicate with the UE to transmit the user data from the UE to the host.

107. The host of the previous 2 embodiments, wherein:
the processing circuitry of the host is configured to execute a host application, thereby providing the user data; and
the host application is configured to interact with a client application executing on the UE, the client application being associated with the host application.

108. A method implemented by a host configured to operate in a communication system that further includes a network node and a user equipment (UE), the method comprising:
at the host, receiving user data transmitted to the host via the network node by the UE, wherein the UE performs any of the steps of any of embodiments 18-37 and 67-95 to transmit the user data to the host.

109. The method of the previous embodiment, further comprising:
at the host, executing a host application associated with a client application executing on the UE to receive the user data from the UE.

110. The method of the previous embodiment, further comprising:
at the host, transmitting input data to the client application executing on the UE, the input data being provided by executing the host application,
wherein the user data is provided by the client application in response to the input data from the host application.

111. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of embodiments 1-17 and 38-66 to transmit the user data from the host to the UE.

112. The host of the previous embodiment, wherein:
the processing circuitry of the host is configured to execute a host application that provides the user data; and
the UE comprises processing circuitry configured to execute a client application associated with the host application to receive the transmission of user data from the host.

113. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of embodiments 1-17 and 38-66 to transmit the user data from the host to the UE.

114. The method of the previous embodiment, further comprising, at the network node, transmitting the user data provided by the host for the UE.

115. The method of any of the previous 2 embodiments, wherein the user data is provided at the host by executing a host application that interacts with a client application executing on the UE, the client application being associated with the host application.

116. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of embodiments 1-17 and 38-66 to transmit the user data from the host to the UE.

117. The communication system of the previous embodiment, further comprising:
the network node; and/or
the user equipment.

118. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of embodiments 1-17 and 38-66 to receive the user data from a user equipment (UE) for the host.

119. The host of the previous embodiment, wherein:
the processing circuitry of the host is configured to execute a host application, thereby providing the user data; and
the host application is configured to interact with a client application executing on the UE, the client application being associated with the host application.

120. The host of the any of the previous 2 embodiments, wherein the initiating receipt of the user data comprises requesting the user data.

121. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of embodiments 1-17 and 38-66 to receive the user data from the UE for the host.

122. The method of the previous embodiment, further comprising at the network node, transmitting the received user data to the host.

### Abbreviations

At least some of the following abbreviations may be used in this disclosure. If there is an inconsistency between abbreviations, preference should be given to how it is used above. If listed multiple times below, the first listing should be preferred over any subsequent listing(s).
ACK Acknowledgement
AR Augmented reality
BLER Block error rate
BWP Bandwidth part
CD-SSB Cell defined-Synchronization signal and PBCH block
CP Cyclic prefix
CSI-RS Channel state information reference signals
CSSF Carrier-specific scaling factor
DCI Downlink control information
DL Downlink
eMBB Evolved mobile broadband
FDD Frequency division duplex
FR1 Frequency range 1
FR2 Frequency range 2
FR3 Frequency range 3
gNB Next generation Node B (5G base station)
HARQ Hybrid automatic repeat request
IMS IP Multimedia Subsystem
MAC Medium access control
NCD-SSB Non Cell defined-Synchronization signal and PBCH block
NR New radio (5G)
PBCH Physical broadcast channel
PDCCH Physical downlink control channel
PDSCH Physical downlink shared channel
PRS Positioning reference signals
PUCCH Physical uplink control channel
PUSCH Physical uplink shared channel
RAT Radio access technology
RRC Radio resource control
RRM Radio resource management
SCS Subcarrier spacing
SFN System frame number
SMTC SSB measurement timing configuration
SRS Sounding reference signal
SSB Synchronization signal and PBCH block
TDD Time division duplex
UE User equipment
UL Uplink
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
USIM Universal Subscriber Identity Module
UTDOA Uplink Time Difference of Arrival
WCDMA Wide CDMA
WLAN Wide Local Area Network

1.-105. (canceled)

106. A method for a network node to determine a configuration for a User Equipment (UE) to perform a measurement on a second cell while being served by a first cell, the method comprising:
determining whether the measurement is an inter-frequency measurement or an intra-frequency measurement, based on the following:
a frequency of a reference signal of the second cell, and
a reference frequency, which is one of the following: a frequency of a reference signal of an active bandwidth part (BWP) of the UE in the first cell, or a frequency of a reference signal of the first cell.

107. The method of claim 106, further comprising determining whether the measurement is to be performed with or without a measurement gap based on the following:
the frequency of the reference signal of the second cell, and
one or more of the following: the reference frequency, and the active BWP of the UE in the first cell.

108. The method of claim 106, wherein the reference signal of the active BWP of the UE comprises a non-cell-defining synchronization signal and PBCH block (NCD-SSB).

109. The method of claim 106, wherein when no reference frequency is defined for the active BWP of the UE, the reference frequency is the frequency of the reference signal of the first cell.

110. The method of claim 106, wherein:
it is determined that the measurement is an inter-frequency measurement when the reference frequency is different than the frequency of the reference signal of the second cell; and
it is determined that the measurement is an intra-frequency measurement when the reference frequency is same as the frequency of the reference signal of the second cell.

111. The method of claim 106, wherein the reference signal of the first cell is one of the following: a cell-defining synchronization signal and PBCH block (CD-SSB), or a non-cell-defining synchronization signal and PBCH block (NCD-SSB).

112. The method of claim 106, wherein the UE is a reduced bandwidth (RB) UE or a reduced capability (Redcap) UE.

113. The method of claim 106, wherein the reference signal of the second cell is one of the following: a cell-defining synchronization signal and PBCH block (CD-SSB), or a non-cell-defining synchronization signal and PBCH block (NCD-SSB).

114. The method of claim 106, wherein the measurement is of one of the following:
the reference signal of the second cell, or
one of the following other signals of the second cell: channel state information reference signal (CSI-RS), CRS, demodulation reference signal (DMRS), primary synchronization signal (PSS), secondary synchronization signal (SSS), discovery reference signal (DRS), or positioning reference signal (PRS).

115. The method of claim 106, further comprising:
sending the configuration of the measurement to the UE, wherein the configuration identifies the frequency of the first reference signal on the second cell; and
receiving from the UE an indication of a result of the measurement according to the configuration.

116. A method for a User Equipment (UE) served by a first cell to determine a configuration for performing a measurement on a second cell, the method comprising:
determining whether the measurement is an inter-frequency measurement or an intra-frequency measurement based on a reference frequency and a frequency of a reference signal on the second cell, wherein the reference frequency comprises a frequency of a reference signal of an active bandwidth part (BWP) of the UE.

117. The method of claim 116, comprising determining whether the measurement is to be performed with or without a measurement gap based on the following:
the frequency of the reference signal of the second cell, and
one or more of the following: the reference frequency, and the active BWP of the UE in the first cell.

118. The method of claim 116, wherein the reference signal of the active BWP of the UE comprises a non-cell-defining synchronization signal and PBCH block (NCD-SSB).

119. The method of claim 116, when no reference frequency is defined for the active BWP of the UE, the reference frequency is the frequency of the reference signal of the first cell.

120. The method of claim 116, wherein:
it is determined that the measurement is an inter-frequency measurement when the reference frequency is different than the frequency of the reference signal of the second cell; and
it is determined that the measurement is an intra-frequency measurement when the reference frequency is same as the frequency of the reference signal of the second cell.

121. The method of claim 116, wherein the reference signal of the first cell is one of the following: a cell-defining synchronization signal and PBCH block (CD-SSB), or a non-cell-defining synchronization signal and PBCH block (NCD-SSB).

122. The method of claim 116, wherein the UE is a reduced bandwidth (RB) UE or a reduced capability (Redcap) UE.

123. The method of claim 116, wherein the reference signal of the second cell comprises one of the following: a cell-defining synchronization signal and PBCH block (CD-SSB), or a non-cell-defining synchronization signal and PBCH block (NCD-SSB).

124. The method of claim 116, wherein the measurement is of one of the following:
the reference signal of the second cell, or
one of the following other signals of the second cell: channel state information reference signal (CSI-RS), CRS, demodulation reference signal (DMRS), primary synchronization signal (PSS), secondary synchronization signal (SSS), discovery reference signal (DRS), or positioning reference signal (PRS).

125. The method of claim 116, comprising performing the measurement according to the determination of whether the measurement is an inter-frequency measurement or an intra-frequency measurement, thereby obtaining a measurement result.

126. The method of claim 116, further comprising:
receiving a configuration of the measurement from a network node, wherein the configuration identifies at least one of the reference frequency and the frequency of the reference signal on the second cell;
logging the measurement according to the configuration to obtain a measurement result; and
sending to the network node an indication the measurement result.

127. A network node arranged to determine a configuration for a User Equipment (UE) to perform a measurement on a second cell while being served by a first cell, the network node comprising:
a processor; and
a memory operably coupled to the processor and containing instructions that, when executed by the processor, configure the network node to:
determine whether the measurement is an inter-frequency measurement or an intra-frequency measurement, based on the following:
a frequency of a reference signal of the second cell, and
a reference frequency, which is one of the following: a frequency of a reference signal of an active bandwidth part (BWP) of the UE in the first cell, or a frequency of a reference signal of the first cell.

128. A User Equipment (UE) arranged to determine a configuration for performing a measurement on a second cell while being served by a first cell, the UE comprising
a processor; and
a memory operably coupled to the processor and containing instructions that, when executed by the processor, configure the UE to:
determine whether the measurement is an inter-frequency measurement or an intra-frequency measurement based on a reference frequency and a frequency of a reference signal on the second cell, wherein the reference frequency comprises a frequency of a reference signal of an active bandwidth part (BWP) of the UE.
